(19) United States
(12) Patent Application Publication
(10) Pub. No.: US 2024/0248242 A1
(43) Pub. Date: Jul. 25, 2024

(54) Multilayer Optical Film

(71) Applicant: 3M INNOVATIVE PROPERTIES COMPANY, St. Paul, MN (US)

(72) Inventors: Lin Zhao, Woodbury, MN (US); Gilles J. Benoit, Minneapolis, MN (US)

(21) Appl. No.: 18/560,172

(22) PCT Filed: Apr. 27, 2022
(86) PCT No.: PCT/IB2022/053924

§ 371 Date: Nov. 10, 2023

Related U.S. Application Data
(60) Provisional application No. 63/192,690, filed on May 25, 2021.

(51) Int. Cl. G02B 5/28

(52) U.S. Cl. CPC G02B 5/287

(57) ABSTRACT

A multilayer optical film includes a plurality of polymeric layers transmitting at least 30% of a substantially normally incident light having a first wavelength and polarized along an in-plane first direction of the polymeric layers. Each of the polymeric layers has an average thickness of less than about 500 nm. First, second and third polymeric layers in the plurality of polymeric layers are disposed sequentially adjacent to each other and have respective indices of refraction n1, n2 and n3 along the first direction at the first wavelength and respective average thicknesses d1, d2 and d3. n2d2 can be within about 40% of m(n1d1+n3d3), where m is a positive integer.

### BACKGROUND

A multilayer optical film can include a plurality of alternating polymeric layers to provide a reflection band.

### SUMMARY

The present description relates generally to optical films including a plurality of layers. The plurality of layers can include layers resulting in a reflection band in a predetermined wavelength range and can include one or more additional layers where each additional layer is substantially thicker than adjacent layers and where the one or more additional layers result in one or more transmission bands in the predetermined wavelength range.

In some aspects, the present description provides a multilayer optical film including a plurality of polymeric layers transmitting at least 30% of a substantially normally incident light having a first wavelength and polarized along an in-plane first direction of the polymeric layers. Each of the polymeric layers has an average thickness of less than about 500 nm. First, second and third polymeric layers in the plurality of polymeric layers are disposed sequentially adjacent to each other and have respective indices of refraction n1, n2 and n3 along the first direction at the first wavelength and respective average thicknesses d1, d2 and d3. n2d2 can be within about 40% of m(n1d1+n3d3), where m is a positive integer.

In some aspects, the present description provides a multilayer optical film including a first plurality of first polymeric layers alternating with a second plurality of second polymeric layers. A difference between average refractive indices of the first polymeric layers and average refractive indices of the second polymeric layers along an in-plane first direction of the multilayer optical film in a predetermined wavelength range of between about 50 nm and about 150 nm wide is sufficiently large and thicknesses of the first and second polymeric layers change across at least a portion of a thickness of the multilayer optical film so that the multilayer optical film has an average optical reflectance of at least 50% for a substantially normally incident light polarized along the in-plane first direction in the predetermined wavelength range. For at least one group of three adjacent and sequentially arranged polymeric layers in the pluralities of first and second polymeric layers, the three polymeric layers have respective average thicknesses d1, d2 and d3. d2 can be within about 40% of m(d1+d3), where m is a positive integer.

In some aspects, the present description provides a multilayer optical film including a plurality of optical repeat units (ORUs) numbering at least 10 in total. Each of the ORUs includes at least two polymeric layers. Each of the ORUs has an optical thickness substantially equal to a half of a wavelength in a predetermined wavelength range extending from about 300 nm to about 2500 nm. At least first and second ORUs in the plurality of ORUs has optical thicknesses substantially equal to a half of respective wavelengths L1 and L2 that are within 100 nm of each other. The first and second ORUs has a single polymeric first layer disposed therebetween, where the first layer having an optical thickness substantially equal to a half of a wavelength L3 disposed between L1 and L2.

In some aspects, the present description provides a multilayer optical film including a plurality of polymeric first layers and one or more polymeric second layers. Each of the first and second layers can have an average thickness of less than about 400 nm. For each of the second layers, the second layer has an average thickness d2 and is disposed between, and adjacent to, two of the first layers having a maximum thickness d1, where d2>1.3 d1.

In some aspects, the present description provides an optical film including a spacer layer disposed between first and second optical mirrors, such that for a substantially normally incident light polarized along a same in-plane first direction of the optical film, first and second wavelengths spaced apart by about 2 nm to about 100 nm, and a third wavelength disposed between the first and second wavelengths: the first and second optical mirrors have respective optical transmittances T1 and T2 at the first wavelength, respective optical transmittances T1′ and T2′ at the second wavelength, and respective optical transmittances T1″ and T2″ at the third wavelength, where T2>2T1 and T1′>2T2′; and the optical film has an optical transmittance T at the third wavelength, where T>T1″ and T2″.

In some aspects, the present description provides an optical film including a plurality of first layers disposed on a plurality of second layers, such that for a substantially normally incident light polarized along a same in-plane first direction, an optical transmittance of each of the pluralities of first and second layers versus wavelength has a transmission stop band including a left band edge (LBE) at a short wavelength side of the transmission stop band where the transmittance generally decreases with increasing wavelength, and a right band edge (RBE) at a long wavelength side of the transmission stop band where the transmittance generally increases with increasing wavelength, where the transmission stop band can be at least 20 nm wide, and an average transmittance across the transmission stop band can be less than about 10%. The RBE of the plurality of the first layers intersects the LBE of the plurality of second layers at at least a first transmittance intersection point between about 5% and about 50%.

In some aspects, the present description provides a multilayer optical film including a plurality of optical repeat units (ORUs) and a single cavity layer sequentially arranged along a thickness direction of the optical film so that the single cavity layer is disposed between first and second ORUs in the plurality of ORUs. The ORUs number at least 30 in total. Each of the ORUs has at least two layers. Each of the at least two layers has an average thickness of less than about 500 nm. The ORUs are sequentially numbered along the thickness direction. A plot of an optical thickness of the sequentially numbered ORUs as a function of the corresponding number in the sequence includes a monotonic first portion that extends across at least 10 of the ORUs and includes the first and second ORUs, such that a best linear fit applied to the ORUs in the monotonic first portion of the sequence has an optical thickness M1 at the sequence number corresponding to the first ORU. An absolute value of a difference between M1 and an optical thickness of the single cavity layer can be less than about 10%.

In some aspects, the present description provides a multilayer optical film including a resonant cavity resonant at at least one resonant wavelength. The resonant cavity is formed by disposing a polymeric cavity layer between multilayer polymeric first and second optical mirrors. Each of the first and second optical mirrors includes a plurality of polymeric layers numbering at least 10 in total. Each of the polymeric layers has an average thickness of less than about 500 nm. Each of the first and second optical mirrors can have an optical reflectance of at least 25% for substantially normally incident light at the at least one resonant wavelength. For an incident light substantially normally incident on the multilayer optical film at the at the least one resonant wavelength, the first and second optical mirrors reflects portions of the incident light in a substantially same direction as respective first and second reflected lights. The reflected lights destructively interfere with each other outside the resonant cavity.

In some aspects, the present description provides a multilayer optical film including a resonant cavity resonant at at least a first resonant wavelength. The resonant cavity formed by disposing a polymeric cavity layer between multilayer polymeric first and second optical mirrors. Each of the first and second optical mirrors includes a plurality of polymeric layers numbering at least 10 in total, where each of the polymeric layers has an average thickness of less than about 500 nm. Each of the first and second optical mirrors can have an optical reflectance of at least 25% for substantially normally incident light and for the first resonant wavelength. For an incident light substantially normally incident on the multilayer optical film and having the first resonant wavelength, the multilayer optical film reflects a first portion of the incident light based on destructive interference of light and transmits a second portion, substantially greater than the first portion, of the incident light based on constructive interference of light.

In some aspects, the present description provides a multilayer optical film including a plurality of optical repeat units (ORUs) numbering at least 10 in total. Each of the ORUs includes at least two polymeric layers, where each of the polymeric layers can have an average thickness of less than about 500 nm. A single cavity layer is disposed between, and adjacent to, first and second ORUs in the plurality of ORUs, such that for a substantially normally incident light having a predetermined wavelength and polarized along an in-plane first direction of the multilayer optical film, each of the first and second ORUs reflects, by constructive interference, a portion of the incident light toward the other one of the first and second ORUs as respective first and second reflected lights. The single cavity layer constructively interferes the first and second reflected lights.

In some aspects, the present description provides a multilayer optical film including a plurality of optical repeat units (ORUs) numbering at least 10 in total, where each of the ORUs has at least two polymeric layers. Each of the polymeric layers can have an average thickness of less than about 500 nm. A single cavity layer is disposed between, and adjacent to, first and second ORUs in the plurality of ORUs. Each of the first and second ORUs have an optical thickness substantially equal to half of a same predetermined wavelength, such that for a substantially normally incident light having the predetermined wavelength and polarized along an in-plane first direction of the multilayer optical film, the multilayer optical film reflects a first portion of the incident light based on destructive interference of light and transmits a second portion, substantially greater than the first portion, of the incident light based on constructive interference of light.

In some aspects, the present description provides a multilayer optical film including a plurality of first layers and a plurality second layers. Each of the first and second layers has an average thickness of less than about 500 nm. For each of the second layers: the second layer is disposed between, and adjacent to, two of the first layers and has an average thickness that is greater than an average thickness of each of the two first layers; and the second layer causes the multilayer optical film to have a different local peak optical transmittance of greater than about 40%.

In some aspects, the present description provides a multilayer optical film including a plurality of first layers and a plurality second layers sequentially arranged and numbered along a thickness direction of the optical film so that each of the second layers is disposed between, and adjacent to, two of the first layers. Each of the first and second layers has an average thickness of less than about 500 nm. The second layers can be sufficiently near one another in the sequence of the layers that, in combination, they cause the multilayer optical film to have a peak optical transmittance of greater than about 40%.

These and other aspects will be apparent from the following detailed description. In no event, however, should this brief summary be construed to limit the claimable subject matter.

### BRIEF DESCRIPTION OF THE DRAWINGS

FIG. 1A is a schematic cross-sectional view of a multilayer optical film, according to some embodiments.

FIG. 1B is a schematic cross-sectional view of a portion of the multilayer optical film of FIG. 1A.

FIG. 2A is a schematic cross-sectional view of a multilayer optical film including a layer disposed between first and second optical mirrors, according to some embodiments.

FIGS. 2B-2C are schematic cross-sectional views of the first and second optical mirrors of FIG. 2A.

FIG. 3A is a plot of optical transmittances of first and second optical mirrors versus wavelength, according to some embodiments.

FIG. 3B is a plot of portions of the optical transmittances versus wavelength of FIG. 3A and of an optical transmittance versus wavelength of a multilayer optical film including the first and second optical mirrors of FIG. 3A and a cavity or spacer layer therebetween, according to some embodiments.

FIGS. 4A-4C are plots of layer thickness versus layer number for a multilayer optical film, according to some embodiments.

FIGS. 5A-5C are plots of optical thicknesses of the optical repeat units (ORUs) of a multilayer optical film versus ORU number, according to some embodiments.

FIGS. 6A-6B are plots of wavelengths corresponding to twice an optical thickness of an ORU versus ORU number in an optical film, according to some embodiments.

FIG. 7A is a plot of optical transmittance and optical absorptance of a multilayer optical film versus wavelength for light substantially normally incident on the optical film, according to some embodiments.

FIGS. 7B-7C are plots of portions of the optical transmittance versus wavelength of FIG. 7A.

FIGS. 8A-8C are plots of layer thickness versus layer number for various optical films, according to some embodiments.

FIGS. 9A-9C are plots of optical transmittance versus wavelength for substantially normally incident light for optical films having the layer thickness profiles of FIGS. 8A-8C, respectively, according to some embodiments.

FIG. 10 is a plot of optical transmittance versus wavelength for substantially normally incident light for films having spacer or cavity layers with different thicknesses, according to some embodiments.

FIGS. 11A-11D are plots of layer thickness versus layer number for an optical film including three spaced apart spacer or cavity layers, according to some embodiments.

FIG. 12 is a plot of optical transmittance versus wavelength for an optical film having the layer thickness profile of FIGS. 11A-11D for substantially normally incident light, according to some embodiments.

FIGS. 13A-13B is a plot of layer thickness versus layer number for an optical film with four spacer or cavity layers, according to some embodiments.

FIG. 14 is a plot of optical transmittance versus wavelength for an optical film having the layer thickness profile of FIGS. 13A-13B for substantially normally incident light, according to some embodiments.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

Multilayer optical films including alternating polymeric layers can be used to provide desired reflection and transmission in desired wavelength ranges by suitable selection of layer thicknesses and refractive index differences as generally described in U.S. Pat. No. 5,882,774 (Jonza et al.); U.S. Pat. No. 6,179,948 (Merrill et al.); U.S. Pat. No. 6,783,349 (Neavin et al.); U.S. Pat. No. 6,967,778 (Wheatley et al.); and U.S. Pat. No. 9,162,406 (Neavin et al.), for example. The alternating polymeric layers typically include alternating high and low index layers which can be described as optical layers that transmit and reflect light primarily by optical interference. A multilayer optical film including alternating high and low index layers can be described as including a plurality of optical repeat units where each optical repeat unit includes a high index layer and a low index layer. An optical repeat unit is generally the smallest distinct unit of optical layers that repeats along at least a portion of the thickness direction of the optical film. Each optical repeat unit may include one or more layers in addition to the high and low index layers as described in U.S. Pat. No. 5,103,337 (Schrenk et al.); U.S. Pat. No. 5,540,978 (Schrenk); and U.S. Pat. No. 6,207,260 (Wheatley et al.), for example.

For some applications it is desired that an optical film have a high reflectance throughout a predetermined wavelength range such as a visible wavelength range (e.g., about 400 nm to about 700 nm, or about 420 nm to about 680 nm, or about 450 nm to about 650 nm) or a visible-near infrared (NIR) wavelength range (e.g., about 400 nm to about 1200 nm, or about 400 nm to about 1000 nm, or about 400 nm to about 900 nm, or about 420 nm to about 850 nm, or about 450 nm to about 800 nm, or about 500 nm to about 800 nm, or about 550 nm to about 800 nm). However, in some cases, it is also desired to provide transmission for one or more wavelengths within the predetermined wavelength range. For example, the optical film can be used as a reflector for recycling light in a display where the reflector also covers one or more transmitters or detectors (e.g., for fingerprint sensing, face recognition, or for sensing various biometric factors) that operate in narrow wavelength range(s) within the predetermined wavelength range. According to some embodiments of the present description, it has been found that narrow transmission band(s) can be provided within the predetermined wavelength range such that the optical film has a desired high average reflectance (e.g., greater than about 60%, or greater than about 70%, or greater than about 80%) in the predetermined wavelength range while allowing a high transmittance (e.g., greater than about 80%, or greater than about 85%, or greater than about 90%) for one or more predetermined wavelengths within the predetermined wavelength range. In some embodiments, this is achieved by utilizing a stack of optical layers to produce a reflection band and including one or more additional optical layers in the stack where each of the additional optical layers has a thickness substantially greater (e.g., at least 50% greater) than adjacent optical layers on each side of the additional optical layer.

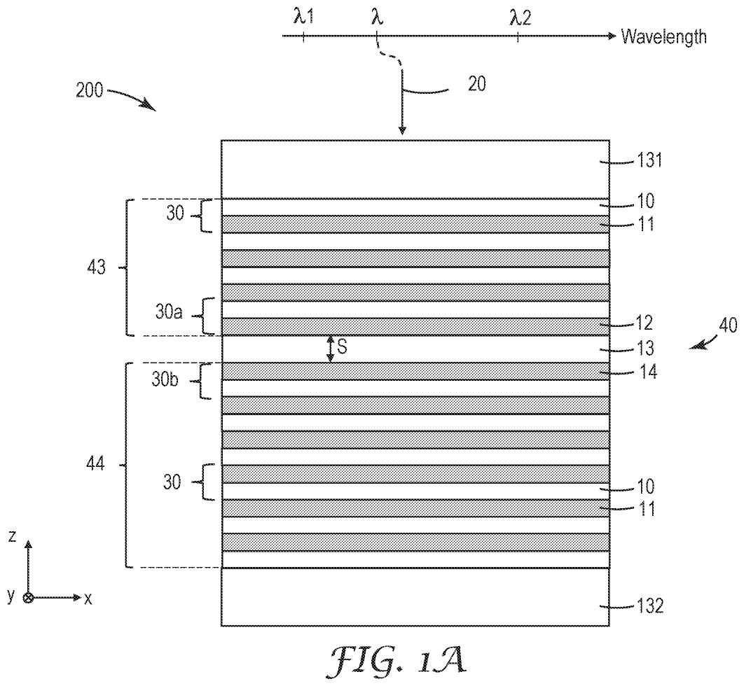

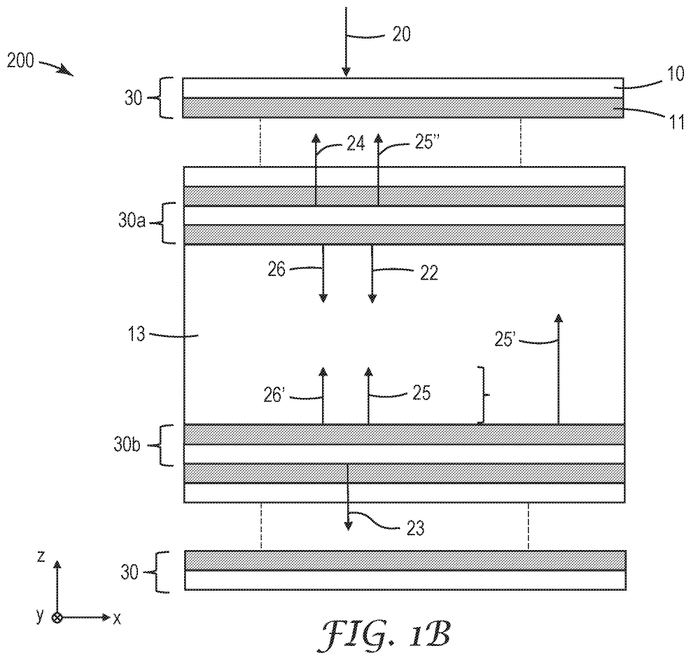

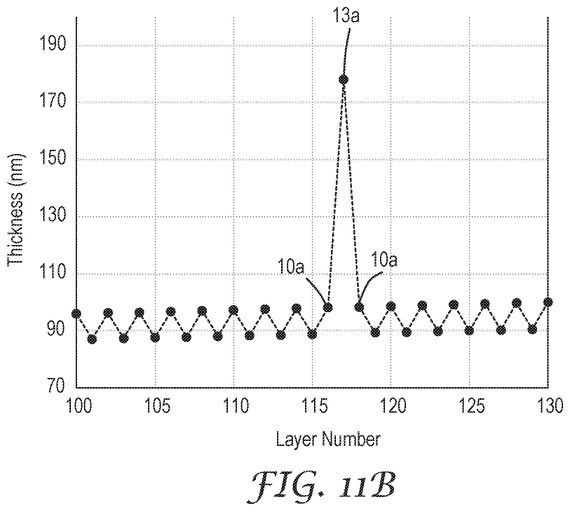

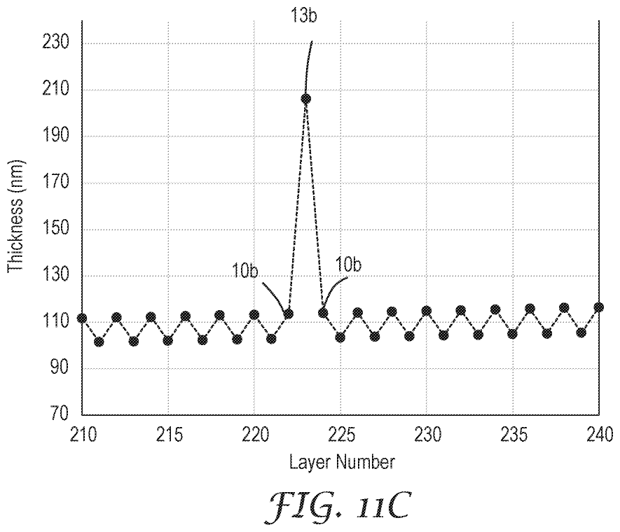

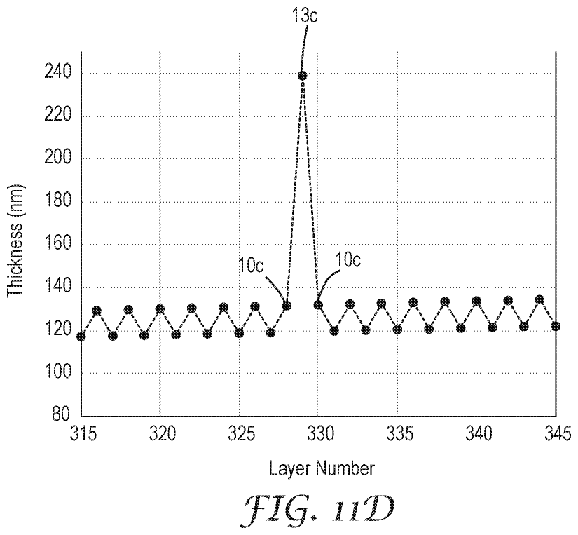

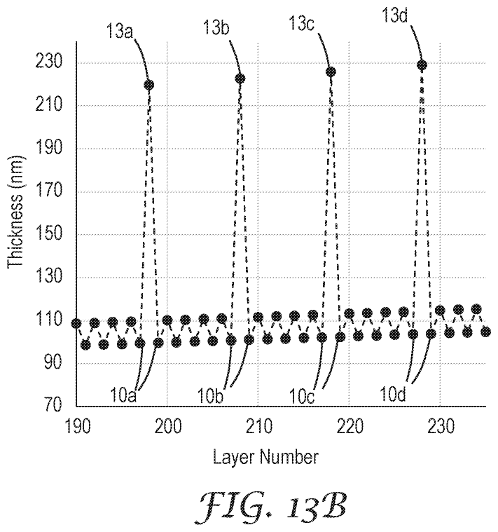

FIG. 1A is a schematic cross-sectional view of a multilayer optical film 200 including a plurality of polymeric layers 10, 11, according to some embodiments. Each of the polymeric layers 10, 11 can have an average thickness of less than about 500 nm, or less than about 400 nm, or less than about 300 nm, or less than about 250 nm, or less than about 200 nm. Each of the polymeric layers 10, 11 can have an average thickness greater than about 30 nm, or greater than about 40 nm, or greater than about 50 nm, for example. The optical film 200 can also include other layers having a thickness greater than about 500 nm. For example, the optical film 200 can include skin layers 131 and 132 where the plurality of polymeric layers 10, 11 are disposed between the skin layers 131 and 132. Each of the skin layers 131, 132 may have an average thickness greater than about 500 nm, or greater than about 1 micrometer, or greater than about 2 micrometers. The average thickness of each of the skin layers 131 and 132 can be up to about 20 micrometers, for example. The optical film 200 may further include protective boundary layer(s) disposed between packets of optical layers and having an average thickness in any of the ranges described for the skin layers. The skin layers and/or the protective boundary layer(s) may be formed from the polymeric material of the layers 10 or of the layers 11, for example. The plurality of polymeric layers 10, 11 includes a layer 13 having an average thickness S which is typically greater than thickness of adjacent layers 12, 14 in the plurality of polymeric layers 10, 11. For example, layer 13 can be one of the layers 10. The layer 13 may be referred to as a spacer layer or a cavity layer, for example. Although only one layer 13 is shown in the schematic illustration of FIG. 1A, additional layers 13 may be included (see, e.g., FIGS. 11A and 13A-13B). The plurality of polymeric layers 10, 11 may be described as including a plurality of first polymeric layers (layers 10, 11 other than layer 13) and one or more second polymeric layers (layer(s) 13). The plurality of polymeric layers 10, 11 may include many more layers than schematically illustrated in FIG. 1A. This is schematically illustrated in FIG. 1B, for example. The number of layers, and the refractive index difference between adjacent layers, may be chosen to give a desired reflection strength over a desired wavelength range. In some embodiments, the plurality of polymeric layers 10, 11 number at least 10 layers in total, or at least 20 layers in total, or at least 30 layers in total, or at least 40 layers in total, or at least 50 layers in total, or at least 100 layers in total, or at least 150 layers in total, for example, and may include up to 1000 layers in total, or up to 600 layers in total, or up to 500 layers in total, or up to 450 layers in total, for example. The plurality of first polymeric layers may be described as including a plurality of optical repeat units 30 where each optical repeat unit include a layer 10 and a layer 11. In some embodiments, the multilayer optical film includes a plurality of optical repeat units where each optical repeat unit includes at least two layers. The two layers can be polymeric layers and can have different compositions. In some embodiments, the multilayer optical film includes a plurality of optical repeat units (ORUs) 30 numbering at least 10 in total, or at least 20 in total, or at least 30 in total, or at least 40 in total, or at least 50 in total, or at least 75 in total, or at least 100 in total, or at least 125 in total, or at least 150 in total, for example, and may include ORUs numbering up to 1000 in total, or up to 600 in total, or up to 400 in total, or up to 300 in total, or up to 250 in total for example.

In some cases, the optical transmission spectra for the optical film 200 may be specified for a substantially normally incident (e.g., within 30 degrees, or 20 degrees, or 10 degrees of normally incident) light 20, for example. The light 20 may be polarized along the x-axis or along the y-axis, for example, referring to the illustrated x-y-z coordinate system, or may be unpolarized. The polarization state for obliquely incident light, for example, may be described as being along an in-plane first direction, for example, when the electric field of the light projected into the plane of the film is parallel to the first direction. The light 20 may have a wavelength λ in a predetermined wavelength range of λ1 to λ2. λ1 may be about 300 nm, or about 350 nm, or about 380 nm, or about 400 nm, or about 420 nm, or about 450 nm, for example. λ2 may be about 2500 nm, or about 2000 nm, or about 1600 nm, or about 1350 nm, or about 1200 nm, or about 1000 nm, or about 900 nm, or about 800 nm, or about 700 nm, or about 680 nm, or about 650 nm, for example. In some embodiments, the optical film 200 may be an optical mirror (e.g., for substantially normally incident light 20 and for at least one wavelength in the predetermined wavelength range, the optical mirror can have an optical reflectance of greater than about 60%, or greater than about 70%, or greater than about 80% for each of two mutually orthogonal polarization states) or a reflective polarizer (e.g., for substantially normally incident light and for at least one wavelength in the predetermined wavelength range, the reflective polarizer can have an optical reflectance of greater than about 60%, or greater than about 70%, or greater than 80% for light having a first polarization state (e.g., polarized along the x-axis) and an optical transmittance of greater than about 60%, or greater than about 70%, or greater than about 75% for light having an orthogonal second polarization state (e.g., polarized along the y-axis)).

The multilayer optical film 200 (or the optical film 210 described elsewhere herein) can be formed from polymeric materials conventionally used in multilayer optical films. Suitable materials for the various layers in the multilayer optical film 200 (or 210) include, for example, polyethylene naphthalate (PEN), coPEN (copolyethylene naphthalate terephthalate copolymer), polyethylene terephthalate (PET), polyhexylethylene naphthalate copolymer (PHEN), glycol-modified PET (PETG), glycol-modified PEN (PENG), various other copolyesters such as those described elsewhere herein, syndiotactic polystyrene (sPS), polymethyl methacrylate (PMMA), coPMMA (a copolymer of methyl methacrylate and ethyl acrylate), or blends thereof. In some embodiments, the layers 10, 11 include alternating first and second layers, where the first layers comprise PEN or PET, for example, and the second layers comprise PMMA or coPMMA, for example. Other suitable materials for the various layers in the multilayer optical film 200 include those described in U.S. Pat. No. 5,103,337 (Schrenk et al.); U.S. Pat. No. 5,540,978 (Schrenk); U.S. Pat. No. 5,882,774 (Jonza et al.); U.S. Pat. No. 6,179,948 (Merrill et al.); U.S. Pat. No. 6,207,260 (Wheatley et al.); U.S. Pat. No. 6,783,349 (Neavin et al.); U.S. Pat. No. 6,967,778 (Wheatley et al.); U.S. Pat. No. 9,069,136 (Weber et al.); and U.S. Pat. No. 9,162,406 (Neavin et al.), for example. Suitable sPS can be obtained from Idemitsu Kosan Co., Ltd. (Tokyo, Japan), for example. Atactic polystyrene (aPS) can optionally be blended with sPS (e.g., at about 5 to about 30 weight percent aPS) to adjust the refractive indices of the resulting layer and/or to reduce the haze of the layer (e.g., by reducing a crystallinity of the layer). Suitable PMMA can be obtained from Arkema Inc., Philadelphia, PA., for example. Suitable PET can be obtained from Nan Ya Plastics Corporation, America (Lake City, SC), for example. PETG can be described as PET with some of the glycol units of the polymer replaced with different monomer units, typically those derived from cyclohexanedimethanol. PETG can be made by replacing a portion of the ethylene glycol (e.g., about 15 to about 60 mole percent or about 30 to about 40 mole percent) used in the transesterification reaction producing the polyester with cyclohexanedimethanol, for example. Suitable PETG copolyesters include GN071 available from Eastman Chemical Company (Kingsport, TN). PEN and coPEN can be made as described in U.S. Pat. No. 10,001,587 (Liu), for example. Glycol-modified polyethylene naphthalate (PENG) can be described as PEN with some of the glycol units of the polymer replaced with different monomer units and can be made by replacing a portion of the ethylene glycol (e.g., about 15 to about 60 mole percent or about 30 to about 40 mole percent) used in the transesterification reaction producing the polyester with cyclohexanedimethanol, for example. PHEN can be made as described for PEN in U.S. Pat. No. 10,001,587 (Liu), for example, except that a portion of the ethylene glycol (e.g., about 15 to about 60 mole percent, or about 30 to about 50 mole percent, or about 40 mole percent) used in the transesterification reaction is replaced with hexanediol. Other suitable copolyesters include those available under the TRITAN tradename from Eastman Chemical Company (Kingsport, TN) and OKP-1 available from Osaka Gas Chemicals Co., Ltd. (Osaka, Japan), for example.

In some embodiments, the layers 10, 11 include alternating (e.g., higher index) birefringent layers and (e.g., lower index) isotropic layers. For example, the layers 10, 11 can include alternating first and second layers, where the first layers comprise PEN or PET, for example, and the second layers comprise PMMA or coPMMA, for example, where the PEN or PET layers can be birefringent (e.g., biaxially or uniaxially oriented) and the PMMA or coPMMA can be optically isotropic. In some embodiments, the layers 10, 11 include alternating higher and lower index isotropic layers. Suitable isotropic high index layers include PHEN, PENG and OKP-1, for example. Suitable isotropic low index layers include PMMA and coPMMA, for example. The higher and lower indices refer to indices along an in-plane direction which can be taken to be along the block axis in the case of a reflective polarizer. The indices can be evaluated at a wavelength of about 633 nm, for example. In the case of reflective polarizers, birefringent layers can be chosen to define pass and block axes of the reflective polarizer. In the case of optical mirrors, birefringent or isotropic higher index layers can be chosen, for example, based on desired reflection spectra for obliquely incident light. For example, birefringent layers can be chosen to provide refractive index differences between adjacent layers that are different along a thickness direction than along the in-plane direction to alter the reflection spectrum for p-polarized light at oblique incident angles.

In FIGS. 1A-1B, a single cavity layer 13 is disposed between, and adjacent to, first and second ORUs 30a and 30b in the plurality of ORUs 30. FIG. 1B schematically illustrates a portion of light 20 reflected by ORU 30a as reflected light 24, a portion of light 20 transmitted by ORU 30a as transmitted light 22, a portion of light 22 reflected by ORU 30b as reflected light 25, a portion of light 22 transmitted by OUR 30b as transmitted light 23, a portion of light 25 reflected by ORU 30a as reflected light 26, a portion 26′ of light 26 reflected by ORU 30b, light 25′ reflected by ORU 30b being a combination of portions 25 and 26′, a portion 25″ of reflected light 25′ transmitted by ORU 30a, according to some embodiments. The light 20 can have a predetermined wavelength λ and can polarized along an in-plane first direction (e.g., x-direction) of the multilayer optical film 200. The lights 22, 23, 24, 25, 26, 26′, 25′, 25″ can have the same predetermined wavelength and can be polarized along the same in-plane first direction. In some embodiments, each one of the first and second ORUs 30a and 30b reflects, by constructive interference, a portion of the incident light 20 toward the other one of the first and second ORUs as respective first and second reflected lights 26 (or the first reflected light can be the sum of the portions of the incident light 20 reflected from ORU 30a) and 25 (or the second reflected light can be the combination 25′ of the portions of the incident light 20 reflected from ORU 30b), where the single cavity layer constructively interferes the first and second reflected lights. For example, the reflected lights 26 and 25 can undergo multiple reflections at the ORUs 30a and 30b such that portions of the reflected lights propagate substantially in phase in a same direction within the single cavity layer 13 to constructively interfere. For example, the portion 26′ of the reflected light 26 can constructively interfere with the reflected light 25. In some embodiments, the first and second ORUs 30a and 30b reflects, by constructive interference, portions of the incident light 20 in a substantially same direction (e.g., nominally in a same direction such as the minus z-direction or within 20 degrees, or 10 degrees, or 5 degrees of a same direction) as respective first and second reflected lights 24 and 25′ (or 25), where the first and second reflected lights destructively interfere with each other outside the single cavity layer 13. For example, a portion 25″ of the reflected light 25′ can be transmitted through ORU 30a and destructively interfere with reflected light 24 outside the single cavity layer 13 resulting in a reduction of reflected light from the optical film. The ORU 30a, for example, may reflect a different portion 26 of the incident light 20 in a direction opposite that of the reflected light 24.

Destructive interference generally occurs between light waves being about 180 degrees out of phase and results in a reduced amplitude of the combined waves compared to the individual waves. Destructive interference may be substantially complete (e.g., for light waves substantially 180 degrees out of phase and having substantially equal amplitudes) resulting in a substantially zero amplitude of the combined waves, or may be incomplete (e.g., for light waves substantially 180 degrees out of phase and having different amplitudes) resulting in a reduced, but non-zero, amplitude of the combined waves. Constructive interference generally occurs between light waves substantially in phase with one another and results in an increased amplitude of the combined waves compared to the individual waves.

The predetermined wavelength λ can be between about 300 nm and about 2500 nm or can be in a predetermined wavelength range described elsewhere herein. In some embodiments, each of the single cavity layer 13 and the first and second ORUs 30a and 30b has an optical thickness that is substantially equal to half of the predetermined wavelength λ. For example, each of the single cavity layer 13 and the first and second ORUs 30a and 30b can have an optical thickness that is within 5%, or 3%, or 2%, or 1%, or 0.8% of half of the predetermined wavelength λ. In some embodiments, each of the first and second ORUs 30a and 30b has an optical thickness that is substantially equal to half of the predetermined wavelength λ and the single cavity layer 13 has an optical thickness that is substantially equal to a positive integer times half of the predetermined wavelength λ. The positive integer can be in any range described elsewhere herein for the positive integer m. The optical thickness of a layer is the average thickness of the layer times a refractive index of the layer. The refractive index can be determined at the predetermined wavelength λ and for light polarized along the first direction.

The multilayer optical film 200 may be described as including a resonant cavity 40 disposed between reflectors 43, 44. The reflectors 43, 44 may be optical mirrors or reflective polarizers that can each include a plurality of optical repeat units 30. The range of the total number of polymeric layers in each reflector and/or the range of the total number of optical repeat units in each reflector can be about half of any corresponding range described elsewhere herein for the optical film 200. For example, each reflector may include 5 to 500 polymeric layers 10, 11 or may include 5 to 500 optical repeat units 30. In some embodiments, each reflector 43, 44 can include at least 10 polymeric layers 10, 11 in total. In some embodiments, the resonant cavity 40 may be formed by disposing a polymeric cavity layer 13 between multilayer polymeric first and second optical mirrors.

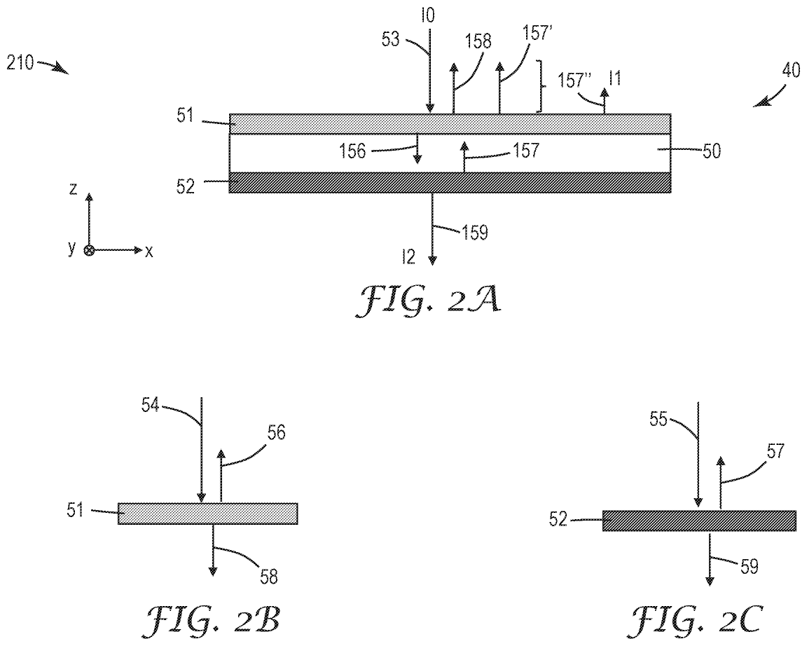

FIG. 2A is a schematic cross-sectional view of a multilayer optical film 210 including a spacer layer 50 (e.g., a polymeric cavity layer) disposed between first and second optical mirrors 51 and 52, according to some embodiments. The optical mirrors 51, 52 can be characterized by reflectance and/or transmittance for substantially normally incident light 54, 55 as schematically illustrated in FIGS. 2B-2C, according to some embodiments. Reflected and transmitted portions 56 and 58 of light 54 substantially normally incident on optical mirror 51 is schematically illustrated in FIG. 2B. Similarly, reflected and transmitted portions 57 and 59 of light 55 substantially normally incident on optical mirror 52 is schematically illustrated in FIG. 2C. The optical properties of the optical mirrors 51 and 52 may be characterized by the reflectance and/or transmittance of respective light 54 and 55 substantially normally incident on the optical mirror in air, for example.

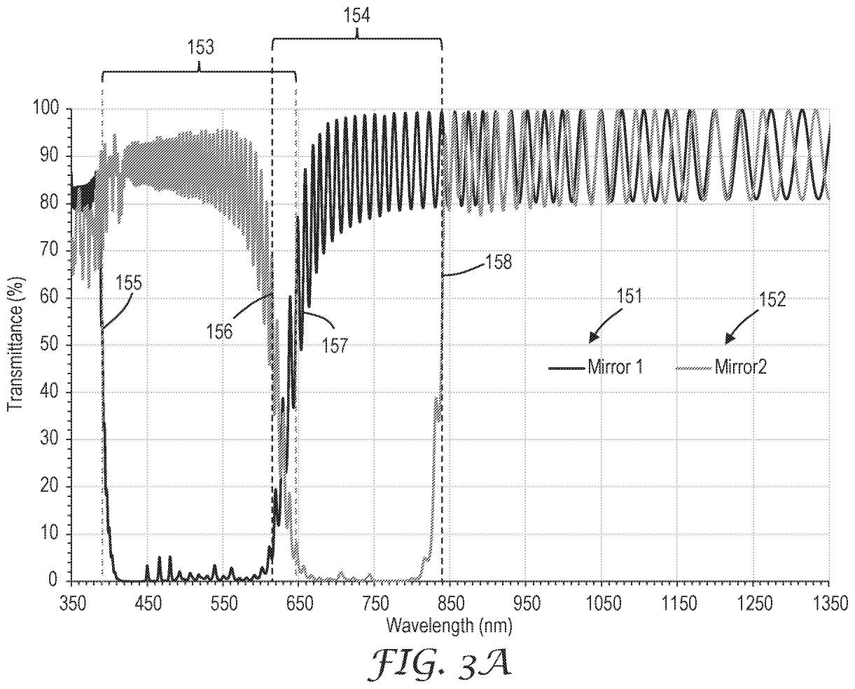

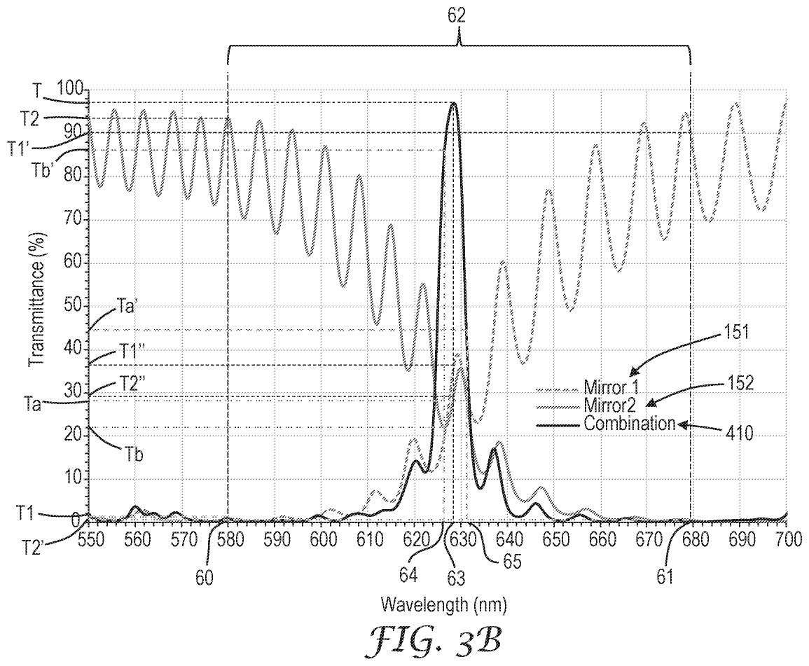

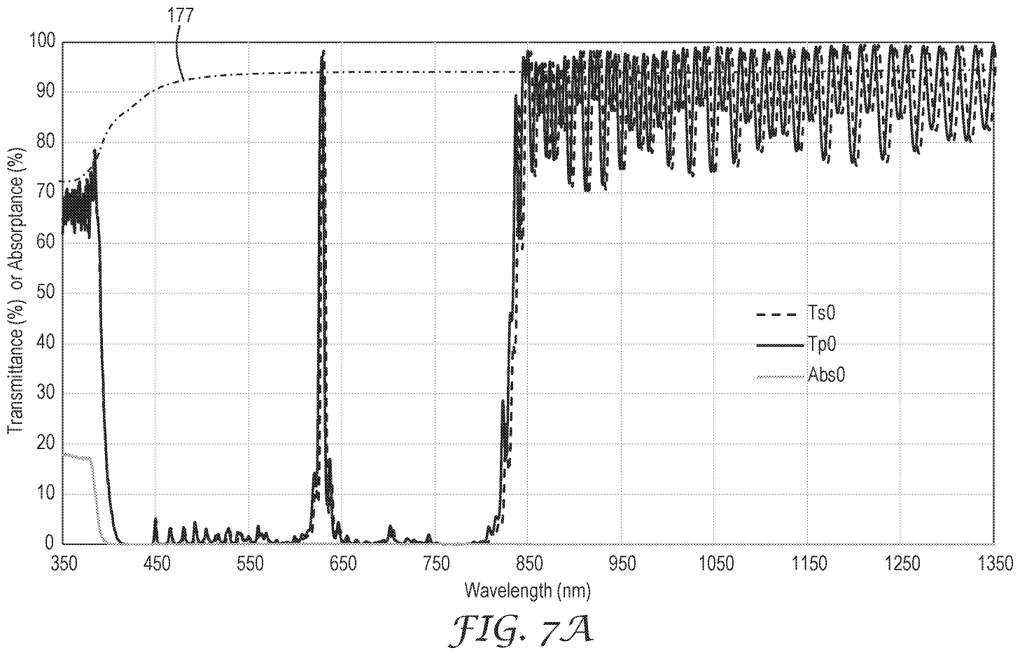

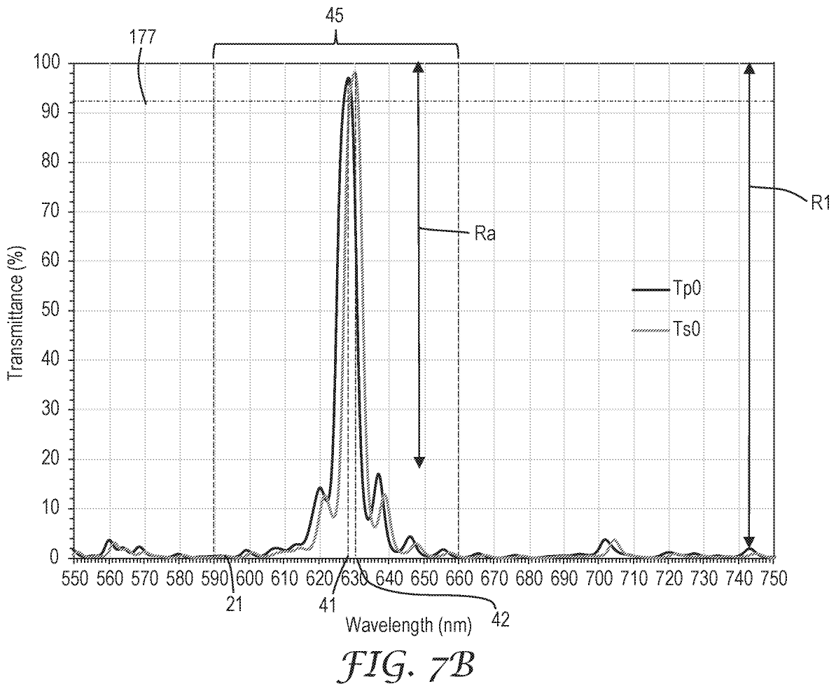

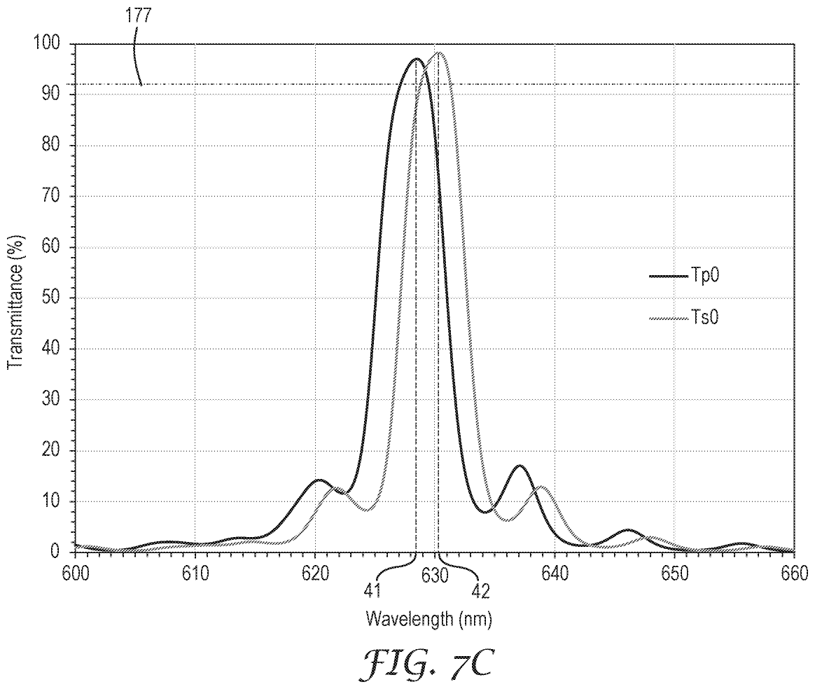

The first and second optical mirrors 51 and 52 may include a plurality of polymeric layers 10, 11 as described further elsewhere herein. In some embodiments, a multilayer optical film 200, 210 includes a resonant cavity 40 resonant at at least one resonant wavelength (e.g., wavelength 41, 42 illustrated in FIGS. 7B-7C; or wavelength 63 illustrated in FIG. 3B). The resonant cavity can be formed by disposing a polymeric cavity layer 13, 50 between multilayer polymeric first and second optical mirrors (e.g., 43 and 44; or 51 and 52). Each of the first and second optical mirrors can include a plurality of polymeric layers 10, 11 numbering at least 10 in total where each of the polymeric layers has an average thickness of less than about 500 nm. The total number of the polymeric layers and the average thickness of the layers can be in any corresponding range described elsewhere herein. In some embodiments, each of the first and second optical mirrors has an optical reflectance of at least 25%, or at least 30%, or at least 35%, or at least 40%, or at least 45%, or at least 50%, or at least 55%, or at least 60% (e.g., 25% to 80% or to 70% or to 65%) for substantially normally incident light 54, 55 (e.g., incident in air) at the at least one resonant wavelength. In some embodiments, each of the first and second optical mirrors has an optical reflectance in a range of 25% to about 50% or to about 45% for substantially normally incident light at the at least one resonant wavelength. A light can be said to be at the at least one resonant wavelength when the light has a wavelength of one of the resonant wavelength(s) or when the light has more than one wavelength and the at least one resonant wavelength includes more than one wavelength such that each wavelength of the light is one of the resonant wavelengths. For example, the optical reflectance can be in any of these ranges for at least a first resonant wavelength of the at least one resonant wavelength. In some embodiments, for an incident light 20 substantially normally incident on the multilayer optical film 200, 210 at the least one resonant wavelength, the first and second optical mirrors reflects portions of the incident light in a substantially same direction as respective first and second reflected lights 158 and 157 (or 24 and 25′) where the first and second reflected lights destructively interfere with each other outside the resonant cavity 40. For example, a portion 157′ of the reflected light 157 can destructively interfere with the reflected light 158 outside the resonant cavity 40 resulting in a light 157″ having a reduced intensity. In some embodiments, for an incident light 20 substantially normally incident on the multilayer optical film 200, 210 and for the at least one resonant wavelength, each of the first and second optical mirrors reflects a portion of the incident light toward the other one of the first and second optical mirrors as respective first and second reflected lights 156 and 157 (or 26 and 25 or 25′), where the resonant cavity 40 constructively interferes the first and second reflected lights. In some embodiments, the multilayer optical film has an optical transmittance for substantially normally incident light of greater than about 50%, or greater than about 60%, or greater than about 70%, or greater than about 80%, or greater than 90% at the at least one resonant wavelength (e.g., the transmittance can be in any of these ranges for at least a first resonant wavelength of the at least one resonant wavelength).

In some embodiments, a multilayer optical film 200, 210 includes a resonant cavity 40 resonant at at least a first resonant wavelength (e.g., at least one of 41, 42, 63). The resonant cavity can be formed by disposing a polymeric cavity layer 13, 50 between multilayer polymeric first (e.g., 43, 51) and second (e.g., 44, 52) optical mirrors, where each of the first and second optical mirrors can include a plurality of polymeric layers 10, 11 numbering at least 10 in total where each of the polymeric layers has an average thickness of less than about 500 nm. The number of layers 10, 11 and/or the average thickness of the layers can be in any range described elsewhere herein.

Each of the first and second optical mirrors can have an optical reflectance of at least 25%, or in a range described elsewhere herein, for substantially normally incident light 54, 55 and for the first resonant wavelength. In some embodiments, for an incident light 20, 53 substantially normally incident on the multilayer optical film 200, 201 and having the first resonant wavelength, the multilayer optical film reflects a first portion (e.g., portion 157″ having intensity I1) of the incident light based on destructive interference of light and transmits a second portion (e.g., portion 159 having intensity I2), substantially greater than the first portion (e.g., I2 can be at least 2 times I1), of the incident light based on constructive interference of light.

In some embodiments, a multilayer optical film 200, 210 includes a plurality of optical repeat units (ORUs) numbering at least 10 in total, where each of the ORUs have at least two polymeric layers 10, 11, and each of the polymeric layers has an average thickness of less than about 500 nm. The number of layers 10, 11 and/or the average thickness of the layers can be in any range described elsewhere herein. In some embodiments, a single cavity layer 13, 50 is disposed between, and adjacent to, first and second ORUs 30a and 30b in the plurality of ORUs, where each of the first and second ORUs has an optical thickness substantially equal to half of a same predetermined wavelength, such that for a substantially normally incident light 20, 53 having the predetermined wavelength and polarized along an in-plane first direction (x-direction) of the multilayer optical film, the multilayer optical film reflects a first portion (e.g., 157″ having intensity I1) of the incident light based on destructive interference of light and transmits a second portion (e.g., 23 or 159 having intensity I2), substantially greater than the first portion (e.g., I2 can be at least 2 times I1), of the incident light based on constructive interference of light. In some embodiments, the single cavity layer has an optical thickness substantially equal to a positive integer times half the predetermined wavelength. The positive integer can be in any range described elsewhere herein (e.g., for m). For example, the positive integer can be less than 5, and may be 1 so that the single cavity layer has an optical thickness substantially equal to half the predetermined wavelength.

In some embodiments, where the multilayer optical film 200, 210 reflects a first portion of the incident light 20, 53 based on destructive interference of light and transmits a second portion of the incident light based on constructive interference of light, the first and second portions can have respective intensities I1 and I2, where I2/I1>2, or I2/I1>3, or I2/I1>4, or I2/I1>5, or I2/I1>6, or I2/I1>7, or I2/I1>8, or I2/I1>9, or I2/I1>10. In some such embodiments, or in other embodiments, the incident light 20, 53 substantially normally incident on the multilayer optical film 200, 210 has an intensity I0, where I2/I0>0.7, or I2/I0>0.75, or I2/I0>0.8, or I2/I0>0.85, or I2/I0>0.9.

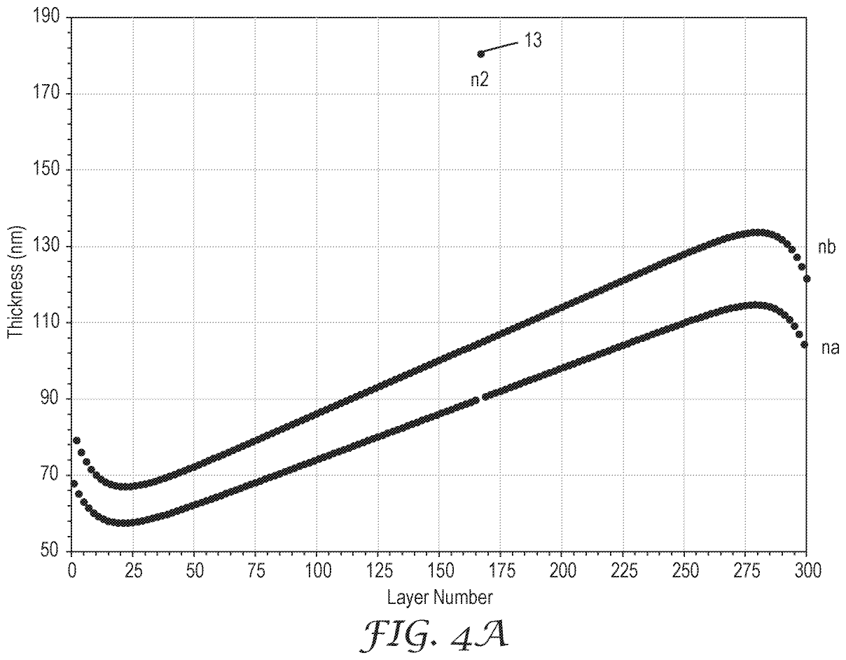

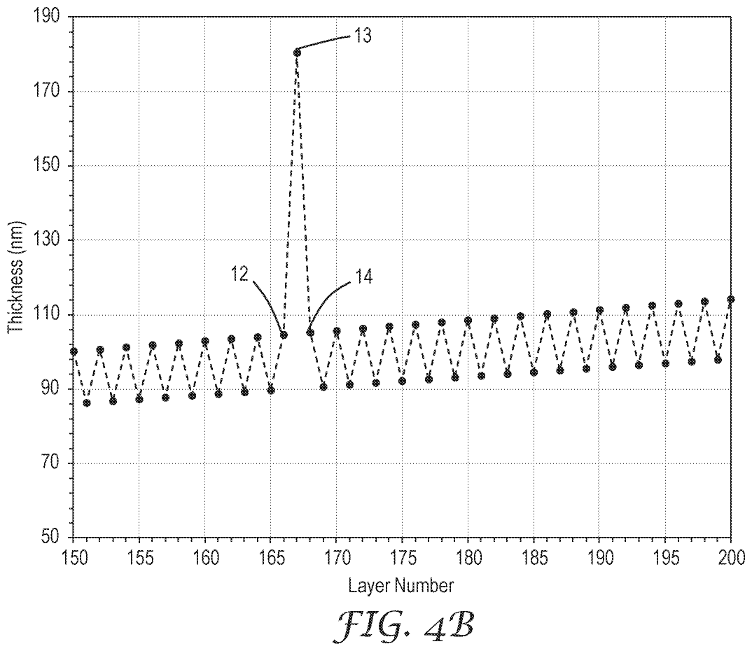

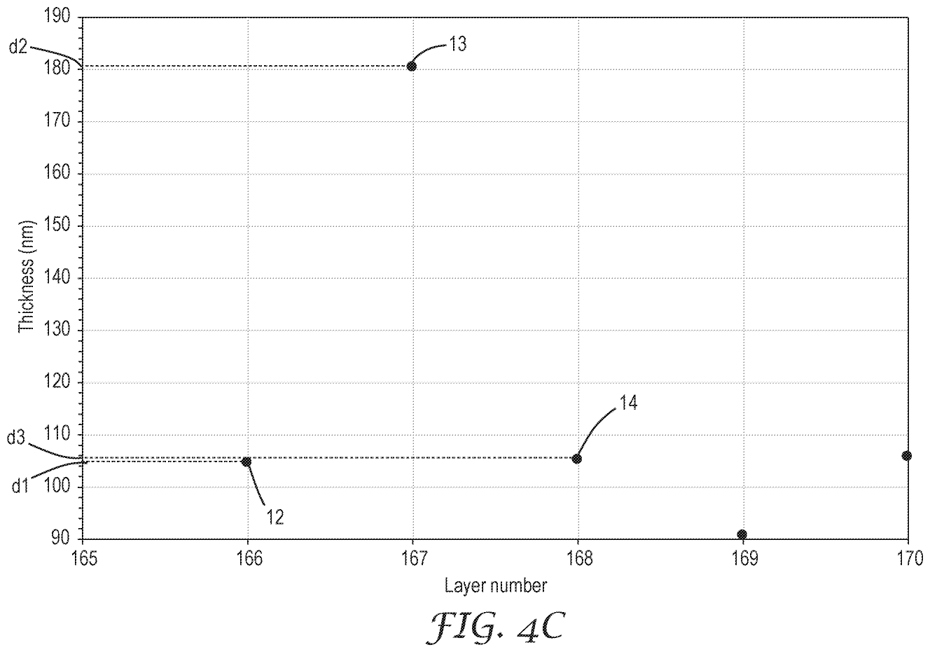

FIG. 3A is a plot of optical transmittances 151 and 152 of respective first and second mirrors (e.g., 43 and 44; or 51 and 52) versus wavelength, according to some embodiments. The optical transmittance 151 includes a transmission stop band 153 having a left band edge (LBE) 155 at a short wavelength side of the transmission stop band 153 where the transmission generally decreases with increasing wavelength, and a right band edge (RBE) 157 at a long wavelength side of the transmission stop band 153 where the transmission generally increases with increasing wavelength. The optical transmittance 152 includes a transmission stop band 154 having a left band edge (LBE) 156 at a short wavelength side of the transmission stop band 154 where the transmission generally decreases with increasing wavelength, and a right band edge (RBE) 158 at a long wavelength side of the transmission stop band 155 where the transmission generally increases with increasing wavelength. FIG. 3B is a plot of the optical transmittances of FIG. 3A and of an optical transmittance 410 of a multilayer optical film including the first and second mirrors and a cavity or spacer layer (e.g., 13 or 50) therebetween, according to some embodiments. The optical transmittances of FIGS. 3A-3B were calculated using standard optical modeling techniques for alternating layers of PEN and PMMA having the layer thickness profile shown in FIGS. 4A-4C where the cavity layer 13 was a PEN layer and where the first and second mirrors included the layers to the left and right, respectively, of the layer 13 in FIG. 4A.

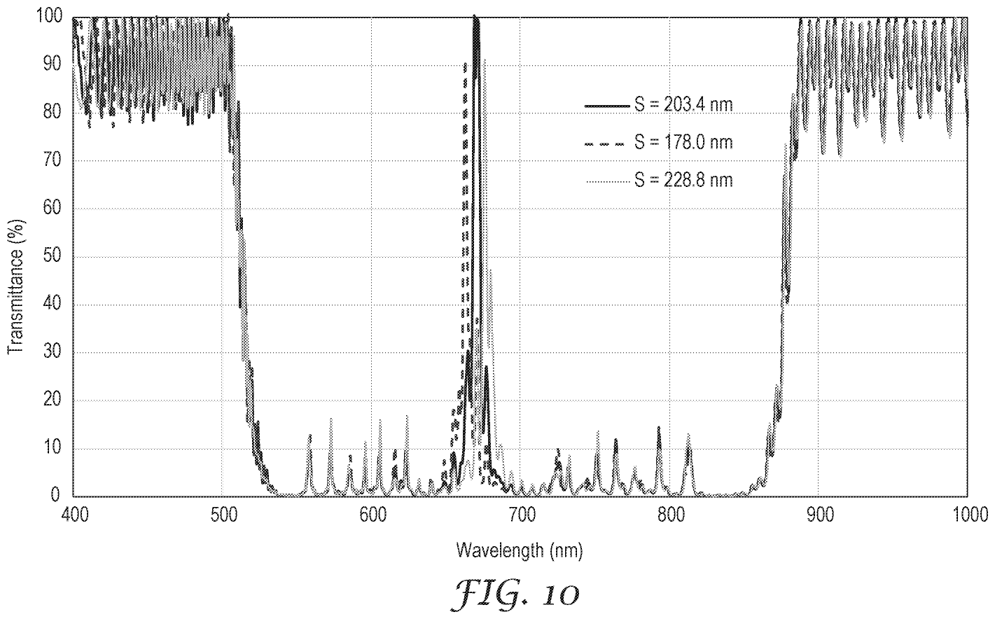

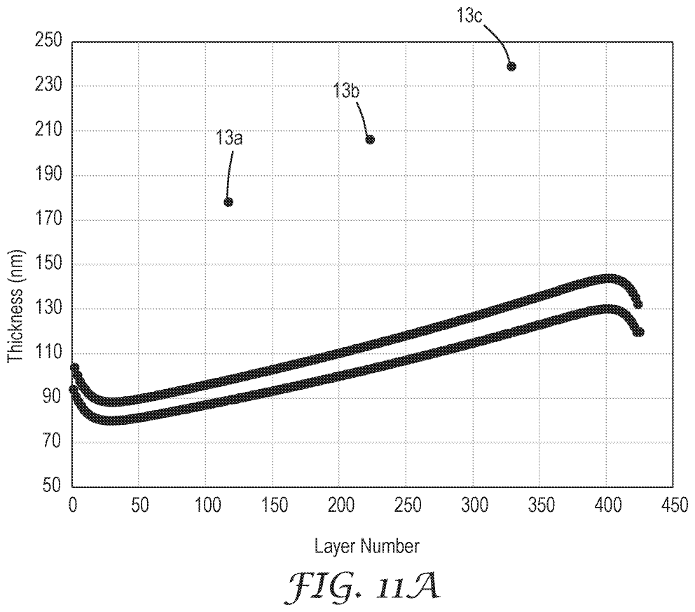

In some embodiments, an optical film 200, 210 includes a spacer layer 13, 50 disposed between first and second optical mirrors (e.g., 43 and 44; or 51 and 52), such that for a substantially normally incident light (e.g., 54, 55) and polarized along a same in-plane first direction (e.g., x-direction) of the optical film, first and second wavelengths 60 and 61 spaced apart (e.g., by wavelength range 62) by about 2 nm to about 100 nm, and a third wavelength 63 disposed between the first and second wavelengths: the first and second optical mirrors have respective optical transmittances T1 and T2 at the first wavelength, respective optical transmittances T1′ and T2′ at the second wavelength, and respective optical transmittances T1″ and T2″ at the third wavelength, and the optical film has an optical transmittance T at the third wavelength. In some embodiments, T2>2T1, T1′>212′, and T>T1″ and T2″ (i.e., T is greater than each of T1″ and T2″). In some such embodiments, or in other embodiments, T2 is greater than 5T1, or 10T1, or 20T1, or 50T1, or 100T1. In some embodiments such embodiments, or in other embodiments, T1′ is greater than 5T2′, or 10T2′, or 20T2′, or 50T2′, or 100T2′. In some such embodiments, or in other embodiments, T is greater than each of T1″ and T2″ by at least a factor of 1.1, or 1.2, or 1.3, or 1.4, or 1.5, or 1.6, or 1.7, or 1.8, or 1.9, or 2. In some such embodiments, or in other embodiments, T1″ and T2″ are each in a range of 10% to 60% or 20% to 50% or to 45%, for example. In some such embodiments, or in other embodiments, changing a thickness S of the spacer layer reduces T (see, e.g., FIG. 10). The changing of the thickness of the spacer layer may include increasing the thickness of the spacer layer or decreasing the thickness of the spacer layer. In some embodiments, both increasing and decreasing the thickness of the spacer layer reduces T.

In some embodiments, an optical film 200, 210 includes a plurality of first layers (e.g., layers 10, 11 in reflector 43) disposed on a plurality of second layers (e.g. layers 10, 11 in reflector 44), such that for a substantially normally incident light 54, 55 polarized along a same in-plane first direction (e.g., x-direction), an optical transmittance 151, 152 of each of the pluralities of first and second layers versus wavelength includes a transmission stop band 153, 154 including a left band edge (LBE) 155, 156 at a short wavelength side of the transmission stop band where the transmittance generally decreases with increasing wavelength, and a right band edge (RBE) 157, 158 at a long wavelength side of the transmission stop band where the transmittance generally increases with increasing wavelength. Each transmission stop band 153, 154 can be at least 20 nm wide, or at least 40 nm wide, or at least 60 nm wide, or at least 100 nm wide and may be up to 500 nm wide, or up to 400 nm wide, for example. An average transmittance across the transmission stop band 153, 154 can be less than about 10%, or less than about 7.5%, or less than about 5%, or less than about 2.5%, or less than about 2%, or less than about 1.5%, or less than about 1%, for example. In some embodiments, the RBE of the plurality of the first layers intersects the LBE of the plurality of second layers at at least a first transmittance intersection point Ta and/or T between about 5% and about 50%, or between about 10% and about 50%, or between about 10% and about 45%, or between about 15% and about 45%, or between about 15% and about 40%, or between about 20% and about 40%, or between about 15% and about 35%, or between about 20% and about 35%, or between about 20% and about 30%. A transmittance intersection point refers to an optical transmittance at a point where the optical transmittances 151 and 152 intersects. At least a first transmittance intersection point being in a specified range (e.g., between about 5% and about 50%) may alternatively be described as at least a first intersection point having an optical transmittance in the specified range. For example, in some embodiments, the RBE of the plurality of the first layers intersects the LBE of the plurality of second layers at at least a first intersection point having an optical transmittance (Ta, T) between about 5% and about 50%, or between about 10% and about 45%, or in a range described elsewhere herein. In some embodiments, the optical film 200, 210 has an optical transmittance Ta′ and/or Tb′ at a wavelength 65 and/or 64, respectively, that corresponds to the at least the first transmittance intersection point that is at least 10%, or 20%, or 30%, or 40%, or 50%, or 100%, or 200%, or 300% greater than the at least the first transmittance intersection point. For example, Tb can be about 20% and Tb′ can be about 86% so that Tb′ is about 330% ((86−20)/20 times 100%) greater than Tb.

FIGS. 4A-4C are plots of layer thickness versus layer number for a multilayer optical film including cavity or spacer layer 13 having an average thickness d2 and disposed between adjacent layers 12 and 14 having respective average thicknesses d1 and d3, according to some embodiments. The optical film includes layers having an index of refraction na, the layer 13 having an index of refraction n2, and layers having an index of refraction nb. Each of the refractive indices may be a refractive index along a same in-plane first direction (e.g., x-direction). In some embodiments, for at least one wavelength in a predetermined wavelength range, nb<na. For example, the lower index layer (e.g., a layer 10) in each optical repeat unit 30 can be thicker than the higher index layer (e.g., a layer 11) in the optical repeat unit such that the optical film can have an f-ratio (ratio of optical thickness of higher index layers to optical thickness of the optical repeat unit) of 0.5. The index of refraction n2 of the layer 13 may be substantially equal to one of na and nb for at least one wavelength in a predetermined wavelength range. In some embodiments, first (12), second (13) and third (14) polymeric layers in the plurality of polymeric layers 10, 11 are disposed sequentially adjacent to each other and have respective indices of refraction n1, n2 and n3 along the first direction at the first wavelength and respective average thicknesses d1, d2 and d3. The indices of refraction n1 and n3 of the first and third layers 12 and 14 may each be one of na and nb and the index of refraction n2 may be the other one of na and nb. In some embodiments, n2 is greater than each of n1 and n3. In some embodiments, n2 is less than each of n1 and n3.

In some embodiments, a difference (e.g., |na−nb|) between average refractive indices of the first polymeric layers 10 and average refractive indices of the second polymeric layers 11 along an in-plane first direction (e.g., x-direction) of the multilayer optical film in a predetermined wavelength range is greater than about 0.05, or greater than about 0.1, or greater than about 0.15. The difference can be up to about 0.4, or up to about 0.35, or up to about 0.3, for example. The predetermined wavelength range may be from about 420 nm to about 680 nm or may be any predetermined wavelength range described elsewhere herein. The average refractive indices for a plurality of layers and a specified wavelength range (e.g., the predetermined wavelength range) refers to an average (e.g., unweighted mean) over the layers (which may be composed of a same material) and over the wavelength range.

It has been found, according to some embodiments, that the position and strength of the transmission peak is robust against changes in cavity thickness. For example, the transmission peak remained above 90% and the peak wavelength shifted by only about 1% when the thickness of the cavity shifted by about 10 to about 25% in some examples. Accordingly, the thickness d2 or optical thickness n2d2 of the layer 13 may be specified to within a substantial tolerance about a target value, according to some embodiments. In some embodiments, n2d2 is within about 40% of m(n1d1+n3d3), where m is a positive integer. For example, |n2d2−m(n1d1+n3d3)|/m (n1d1+n3d3) can be less than about 0.4. In some embodiments, n2d2 is within about 30%, or within about 20%, or within about 10%, or within about 5%, or within about 3% of m(n1d1+n3d3). In some embodiments, d2 is within about 40%, or within about 30%, or within about 20%, or within about 10%, or within about 5% of m(d1+d3), where m is a positive integer. In either case, m may be less than 15, or less than 10, or less than 5. The positive integer m can be 1, 2, 3, or 4, for example. In some embodiments, d2 is within about 40%, or within about 30%, or within about 20%, or within about 10%, or within about 5% of m′(d1+d3) and n2d2 is within about 40%, or within about 30%, or within about 20%, or within about 10%, or within about 5%, or within about 3% of m″(n1d1+n3d3), where m′ and m″ can be in any of the ranges described for m. In some embodiments, m′=m″. The positive integers m′ and m″ may alternatively be denoted m and m′, or m′ and m, for example. In some embodiments, d2 is within about 30%, or within about 20% of m(d1+d3) and n2d2 is within about 20%, or within about 10%, or within about 5%, or within about 3% of m(n1d1+n3d3). In some embodiments, the cavity layer 13 has an optical thickness (n2d2) within about 40% of within about 30%, or within about 20%, or within about 10%, or within about 5%, or within about 3% of the positive integer m times a mean of the optical thickness of the two optical repeat units 30a and 30b adjacent the cavity layer 13. In some embodiments, each of the cavity layer 13 and the two optical repeat units 30a and 30b adjacent the cavity layer 13 have an optical thickness within about 10%, or within about 5%, or within about 3%, or within about 2%, or within about 1%, or within about 0.8% of a half of a same predetermined wavelength. In some embodiments, d2 is less than about 500 nm, or less than about 400 nm, or d2 can be in any of the thickness ranges described elsewhere herein for the polymeric layers 10, 11.

In some embodiments, a multilayer optical film includes a plurality of polymeric first layers 10, 11 and one or more polymeric second layers 13, where each of the first and second layers has an average thickness of less than about 400 nm or in a range described elsewhere herein. In some embodiments, for each of the second layers: the second layer 13 has an average thickness d2 and is disposed between, and adjacent to, two (12, 14) of the first layers having a maximum thickness d1 (here, d1 is the larger of the thickness d1 and d2 illustrated in FIG. 4C, for example), where d2≥1.3 d1. In some embodiments, d2≤3 d1. In some embodiments, 3≥d2/d1≥1.3, or 2.5≥d2/d1≥1.35, or 2.1≥d2/d1≥1.4.

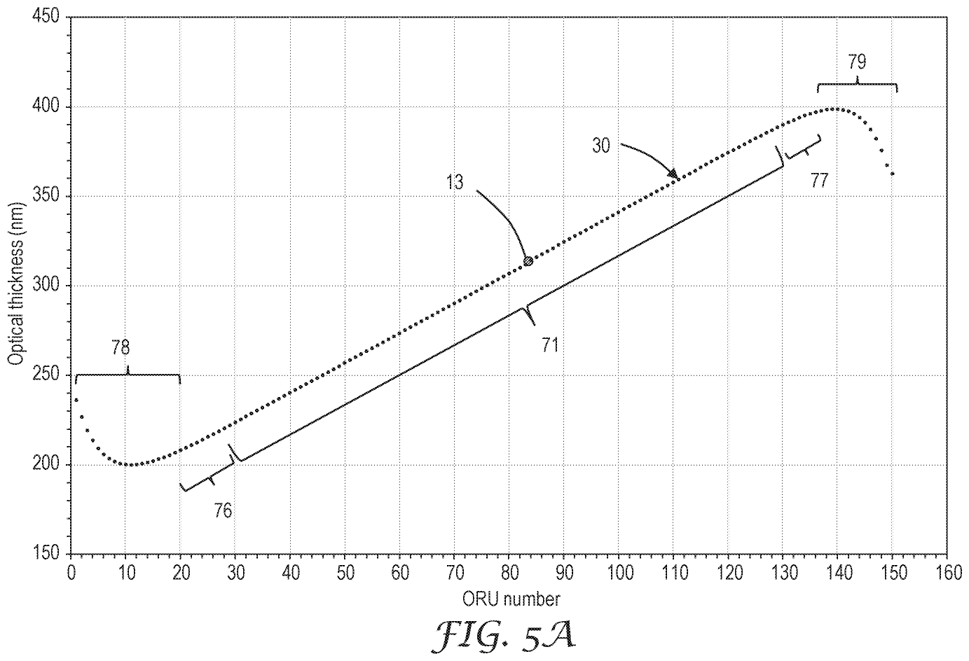

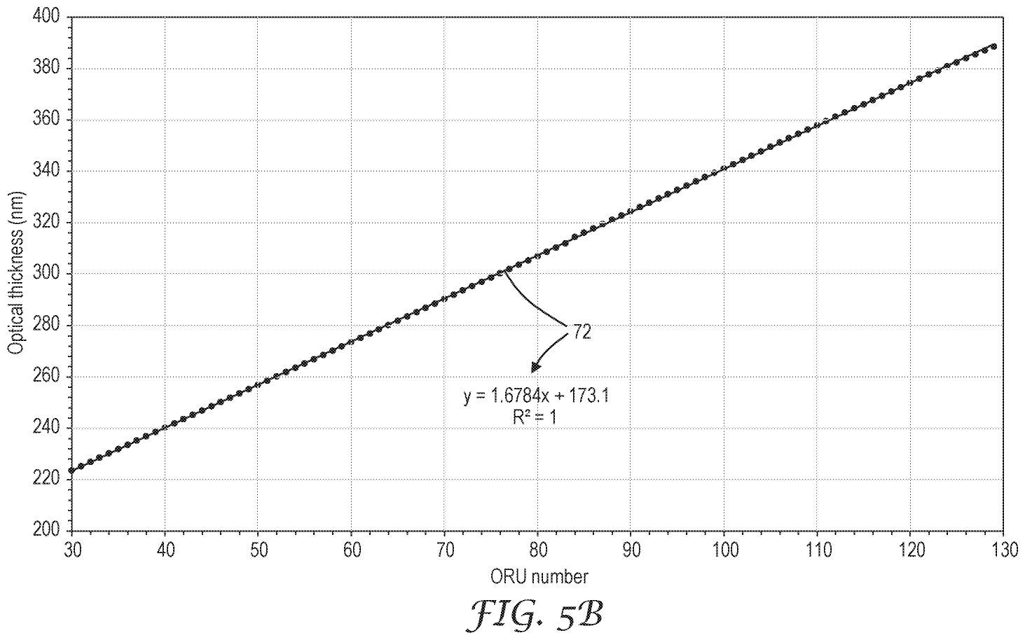

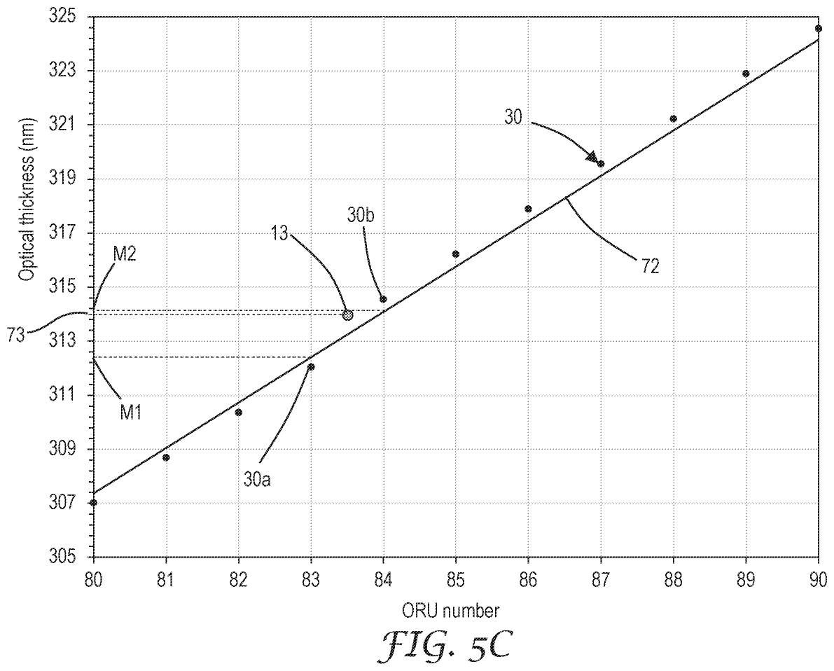

FIGS. 5A-5C are plots of optical thickness of the optical repeat units (ORUs) 30 versus ORU number, according to some embodiments. The plurality of optical repeat units (ORUs) 30 and a single cavity layer 13 are sequentially arranged along a thickness direction (z-direction) of the optical film so that the single cavity layer 13 is disposed between first and second ORUs 30a and 30b in the plurality of ORUs 30. The optical thickness of the layer 13, according to some embodiments, is shown between the ORU numbers of the ORUs 30a and 30b adjacent to the layer 13 in FIGS. 5A and 5C. The ORUs 30 are sequentially numbered along the thickness direction. A plot of an optical thickness of the sequentially numbered ORUs as a function of the corresponding number in the sequence includes a monotonic first portion 71 that extends across at least 10, or at least 20, or at least 30, or at least 40, or at least 50, or at least 60, or at least 70, or at least 80, or at least 90, or at least 100 of the ORUs 30 and includes the first and second ORUs 30a and 30b, such that a best linear fit 72 applied to the ORUs in the monotonic first portion 71 of the sequence has an optical thickness M1 at the sequence number (e.g., at ORU number 83) corresponding to the first ORU 30a. An absolute value of a difference between M1 and an optical thickness 73 of the single cavity layer can be less than about 10%, or less than about 8%, or less than about 6%, or less than about 4%, or less than about 2%, or less than about 1%. The best linear fit 72 can have an optical thickness M2 at the sequence number (e.g., ORU number 84) corresponding to the second ORU 30b. An absolute value of a difference between M2 and the optical thickness 73 of the single cavity layer can be less than about 10%, or less than about 8%, or less than about 6%, or less than about 4%, or less than about 2%, or less than about 1%. The difference expressed as a percent is the larger thickness minus the smaller thickness divided by the larger thickness times 100%. The difference can also be expressed as a length. The absolute value of the difference between M1 and the optical thickness of the single cavity layer can be less than about 15 nm, or less than about 12 nm, or less than about 10 nm, or less than about 8 nm, or less than about 6 nm, or less than about 4 nm, for example. The absolute value of the difference between M2 and the optical thickness of the single cavity layer can be less than about 15 nm, or less than about 12 nm, or less than about 10 nm, or less than about 8 nm, or less than about 6 nm, or less than about 4 nm, for example. The optical thickness of the single cavity layer can be between 0.96 times the smaller of M1 and M2 and 1.04 times the larger of M1 and M2, or between 0.98 times the smaller of M1 and M2 and 1.02 times the larger of M1 and M2, or between 0.99 times the smaller of M1 and M2 and 1.01 times the larger of M1 and M2. In some embodiments, the optical thickness of the single cavity layer is between M1 and M2.

The monotonic first portion 71 is a portion of the sequence where the optical thickness of the ORUs increases with the corresponding number in the sequence or decreases with the corresponding number in the sequence. The monotonic first portion 71 of the sequence may be a linear portion of the sequence. The plot of the optical thickness of the sequentially numbered ORUs as a function of the corresponding number in the sequence may include monotonic second and third portions 76 and 77 adjacent ends of the monotonic first portion 71 and/or may include non-monotonic first and second portions 78 and 79 adjacent the ends of the monotonic first portion 71 or adjacent the monotonic second and third portions 76 and 77. The monotonic first portion 71 can generally be any monotonic portion that extends across at least 10 of the ORUs 30 and includes the first and second ORUs 30a and 30b. In embodiments where a linear portion extends across at least 10 of the ORUs 30 and includes the first and second ORUs 30a and 30b, the monotonic first portion 71 may be taken to be the linear portion.

The best linear fit 72 can be a linear least squares fit. As is known in the art, such fits minimize the sum of squares of residuals where a residual is the difference between data and the fitted line. The least squares analysis allows the r-squared value, sometimes referred to as the coefficient of determination, to be determined. In some embodiments, the best linear fit 72 has an r-squared value of at least 0.9, or at least 0.95, or at least 0.98, or at least 0.99, for example.

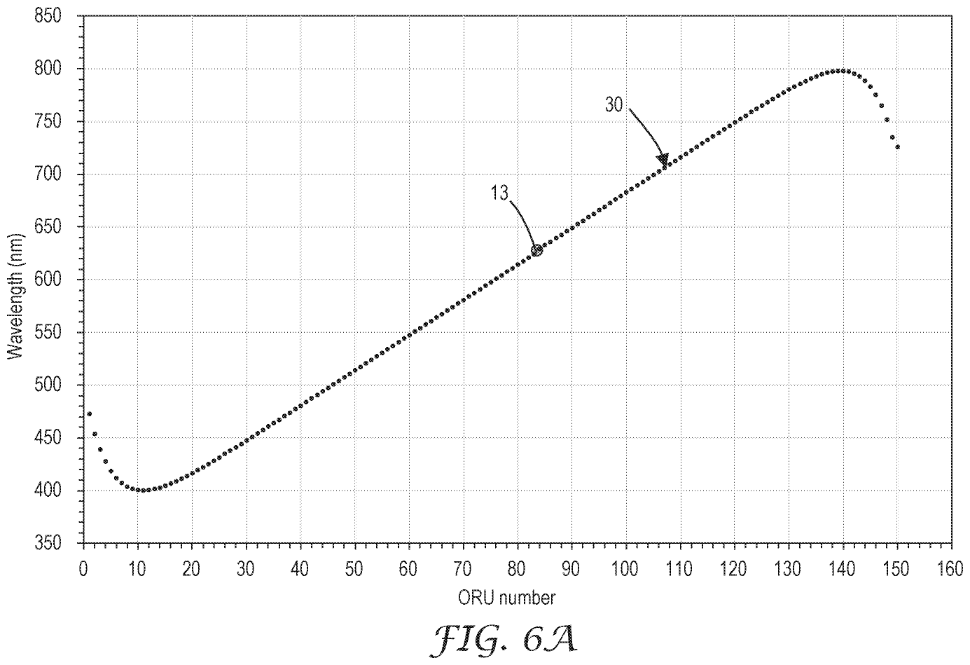

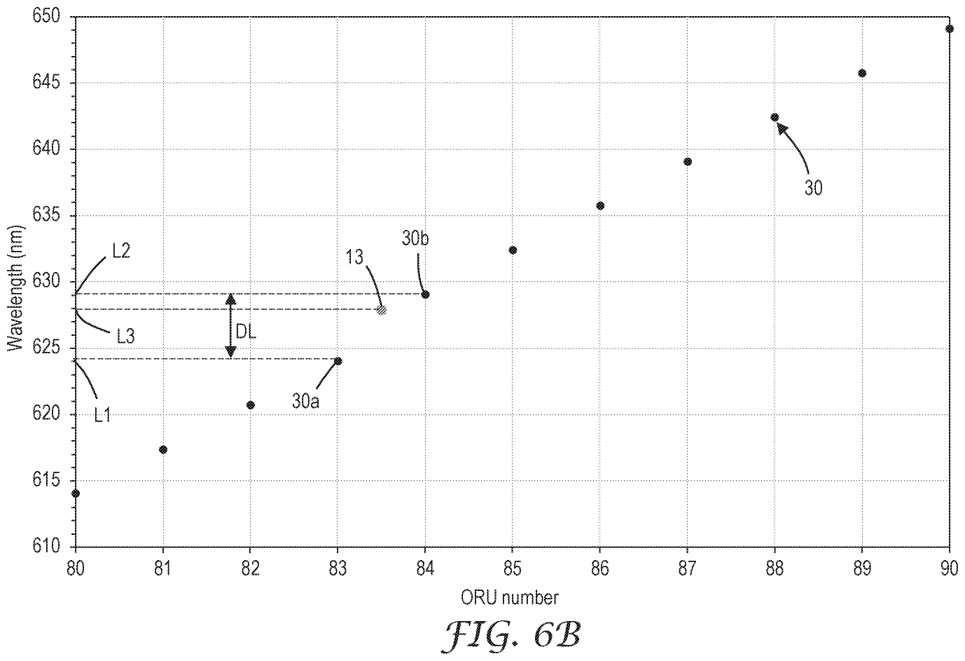

An optical repeat unit may reflect primarily at a wavelength of twice the optical thickness of the optical repeat unit. In some embodiments, each of the ORUs 30 has an optical thickness substantially equal (e.g., equal to within 5%, or 3%, or 2%, or 1%, or 0.8%) to a half of a wavelength in a predetermined wavelength range which may extend from about 300 nm to about 2500 nm, for example, or may be at least 200 nm wide and disposed between about 300 nm and about 2500 nm. FIGS. 6A-6B are plots of wavelengths corresponding to twice an optical thickness of the ORU versus ORU number, according to some embodiments. In some embodiments, at least first and second ORUs 30a and 30b in the plurality of ORUs 30 have optical thicknesses substantially equal to a half of respective wavelengths L1 and L2 that are within 100, or 90, or 80, or 70, or 60, or 50, or 40, or 30, or 20, or 15, or 10 nm of each other (e.g., the difference DL=L2−L1 may be no more than 100 nm or no more than any other of these lengths), where the first and second ORUs 30a and 30b have a single polymeric first layer 13 disposed therebetween. The first layer 13 can have an optical thickness substantially equal to a half of a wavelength L3 disposed between L1 and L2. A difference between L2 and L1 can be at least 1 nm, or at least 2 nm, or at least 3 nm, for example.

In some embodiments, the multilayer optical film 200, 210 transmits at least 30%, or at least 40%, or at least 50%, or at least 60%, or at least 70%, or at least 80%, or at least 90% of a substantially normally incident light 20 having a first wavelength (wavelength 41 illustrated in FIG. 7C) between L1 and L2 and polarized along an in-plane first direction (x-direction) of the multilayer optical film. In some embodiments, the first wavelength is substantially equal to L3. In some embodiments, the multilayer optical film 200, 210 reflects at least 30%, or at least 40%, or at least 50%, or at least 60%, or at least 70%, or at least 80%, or at least 90% of a substantially normally incident light 20 having a second wavelength (e.g., wavelength 21) within about 100 nm of L3 and polarized along the in-plane first direction of the multilayer optical film. The second wavelength can be within about 90 nm, or within about 80 nm, or within about 70 nm, or within about 60 nm, or within about 50 nm, or within about 40 nm, or within about 30 nm, or within about 20 nm, or within about 10 nm of L3, for example.

FIGS. 7A-7C are plots of optical transmittance versus wavelength for light 20 substantially normally incident on optical film 200, 210, according to some embodiments. Tp0 and Ts0 denote optical transmittance for substantially normally incident light polarized along orthogonal in-plane first and second directions (e.g., x- and y-directions). The optical film 200, 210 may have substantially similar optical transmittances Tp0 and Ts0 for each of the polarization states. For example, the optical film can be an optical mirror. In some embodiments, the optical film 200 is a reflective polarizer having the optical transmittance Tp0, for example, for substantially normally incident light polarized along an in-plane first direction and having a high optical transmittance (e.g., greater than about 60%) throughout a wavelength range of about 450 nm to about 800 nm, for example, for substantially normally incident light polarized along the second direction. An optical transmittance 177 for a reflective polarizer for substantially normally incident light polarized along the second direction is schematically indicated. Abs0 denotes optical absorptance for substantially normally incident light. In some embodiments, the optical film 200, 210 and/or the plurality of polymeric layers 10, 11 transmits at least 30%, or at least 40%, or at least 50%, or at least 60%, or at least 70%, or at least 80%, or at least 90% of a substantially normally incident light 20 having a first wavelength (e.g., 41 and/or 42 and/or 63) and polarized along an in-plane first direction (e.g., x-direction) of the polymeric layers. In some such embodiments, or in other embodiments, the optical film 200, 210 reflects at least at least 50%, or at least 60%, or at least 70%, or at least 80%, or at least 90% of the substantially normally incident light 20 having a second wavelength (e.g., 21 illustrated in FIG. 7B and/or 60 and/or 61 illustrated in FIG. 3B) and polarized along the in-plane first direction. The second wavelength can be within about within about 100 nm, or within about 90 nm, or within about 80 nm, or within about 70 nm, or within about 60 nm, or within about 50 nm, or within about 40 nm, or within about 30 nm, or within about 20 nm, or within about 10 nm of the first wavelength. For example, an absolute value of a difference between the first and second wavelengths can be in a range of about 5 nm to about 40 nm or to about 30 nm. The optical film may reflect at least 50%, or 60%, or 70%, or 80%, or 90% of the substantially normally incident light 20 having the second wavelength and polarized along an in-plane second direction orthogonal to the first direction, or the optical film may transmit at least 50%, or at least 60%, or at least 70%, or at least 80%, or at least 90% of the substantially normally incident light 20 having the second wavelength and polarized along an in-plane second direction orthogonal to the first direction. The optical reflectance R1 of the optical film 200, 210 can be expressed as 100% minus the optical transmittance minus the optical absorptance. The optical film 200, 210 can have an optical reflectance of approximately 100% minus the optical transmittance when the optical absorptance is negligible (see, e.g., FIG. 7A). The Ts0, Tp0 curves of FIGS. 7A-7C and the Abs0 curve of FIG. 7A were calculated using standard optical modeling techniques for alternating layers of PEN and PMMA having the layer thickness profile shown in FIGS. 4A-4C where the cavity layer 13 was a PEN layer.

In some embodiments, the resonant cavity 40 (see, e.g., FIG. 1A) is resonant for at least one resonant wavelength (e.g., wavelength 41, 42 illustrated in FIGS. 7B-7C or wavelength 63 illustrated in FIG. 3B). In some embodiments, the at least one resonant wavelength includes a first wavelength (e.g., wavelength 41, 42) and the multilayer optical film 200, 210 has an optical reflectance of greater than about 50%, or greater than about 60%, or greater than about 70%, or greater than about 80%, or greater than about 90% for at least a second wavelength (e.g., wavelength 21) within about 100 nm of the first wavelength. The second wavelength can be within about within about 50 nm, or another range described elsewhere herein, of the first wavelength, for example.

In some embodiments, a multilayer optical film 200, 210 includes a first plurality of first polymeric layers 10 alternating with a second plurality of second polymeric layers 11. The layer 13 can be one of the first polymeric layers 10 or one of the polymeric layers 11, for example. A difference between average refractive indices of the first polymeric layers and average refractive indices of the second polymeric layers along an in-plane first direction (x-direction) of the multilayer optical film in a predetermined wavelength range (e.g., wavelength range 45 illustrated in FIG. 7B) of between about 50 and about 150 nm wide being sufficiently large (e.g., greater than about 0.05 or in a range described elsewhere herein) and thicknesses of the first and second polymeric layers changing across at least a portion of a thickness of the multilayer optical film (e.g., as illustrated in FIGS. 4A-4B, 11A-11D, 13A-13B, for example) so that the multilayer optical film has an average optical reflectance of at least 50%, or at least 60%, or at least 70%, or at least 80%, or at least 85% for a substantially normally incident light 20 polarized along the in-plane first direction in the predetermined wavelength range. An average optical reflectance Ra for the wavelength range 45 is schematically illustrated in FIG. 7B. For the optical transmittance Tp0 illustrated in FIGS. 7A-7C, the average optical reflectance Ra for the wavelength range of 590 nm to 660 nm was 88.4%. In some embodiments, the predetermined wavelength range is between about 50 nm and about 100 nm wide, or between about 50 nm and about 75 nm wide, for example. In some embodiments, for at least one group of three adjacent and sequentially arranged polymeric layers (e.g., layers 12 through 14) in the pluralities of first and second polymeric layers, the three polymeric layers have respective average thicknesses d1, d2 and d3, where d2 can be related to d1 and d3 as described elsewhere herein. For example, d2 can be within about 40% of m(d1+d3), where m is a positive integer. As another example, n2d2 can be within about 40% of m(n1d1+n1d3), where m is a positive integer.

The optical film may be configured have a desired substantial transmittance in narrow wavelength range(s) and a desired substantial reflectance in wavelength ranges adjacent the high transmittance range(s). For example, a peak transmittance can be adjusted by adjusting the thickness of the spacer layer and/or a width of the transmittance range can be adjusted by including more than one sufficiently close spacer layers, as described further elsewhere herein. The substantial transmittance, the substantial reflectance, and the width of the narrow wavelength range(s) may be selected as desired for a particular application. For example, the optical film can have a desired transmittance (e.g., greater than about 60%) for a first wavelength and a desired reflectance (e.g., greater than about 60%) for a second wavelength close to (e.g., within about 30 nm of) the first wavelength.

In some embodiments, for the substantially normally incident light polarized along the in-plane first direction (e.g., x-direction) and for at least a first wavelength (e.g., wavelength 21) in the predetermined wavelength range, the multilayer optical film 200, 210 reflects at least 60%, or at least 70%, or at least 80%, or at least 90%, or at least 95% of the incident light. In some embodiments, for a substantially normally incident light polarized along an in-plane second direction (e.g., y-direction) orthogonal to the first direction and for at least the first wavelength, the multilayer optical film has an optical reflectance of at least 60%, or at least 70%, or at least 80%, or at least 90%, or at least 95%. In some embodiments, for a substantially normally incident light polarized along an in-plane second direction (e.g., y-direction) orthogonal to the first direction and for at least the first wavelength, the multilayer optical film has an optical transmittance of at least 60%, or at least 70%, or at least 80%, or at least 90%. In some embodiments, for a substantially normally incident light 20 polarized along an in-plane first direction (e.g., x-direction) of the multilayer optical film 200, 210, the multilayer optical film has an optical transmittance of at least 30% for a first wavelength (e.g., wavelengths 41 and 42 illustrated in FIGS. 7B-7C) and an optical reflectance of at least 50% for a second wavelength (e.g., wavelength 21 illustrated in FIG. 7B), where the second wavelength can be within about 100 nm, or any other range described elsewhere herein, of the first wavelength. In some embodiments, the optical transmittance is at least 40%, or 50%, or 60%, or 70%, or 80%, or 90% for the first wavelength. In some such embodiments, or in other embodiments, the optical reflectance is at least 50%, or at least 60%, or at least 70%, or at least 80%, or at least 90% for the second wavelength. In some embodiments, for substantially normally incident light polarized along the in-plane first direction, the multilayer optical film 200, 210 has an optical transmittance of at least 70% for the first wavelength and an optical reflectance of at least 80% for a second wavelength, where the second wavelength is within about 30 nm of the first wavelength, for example.

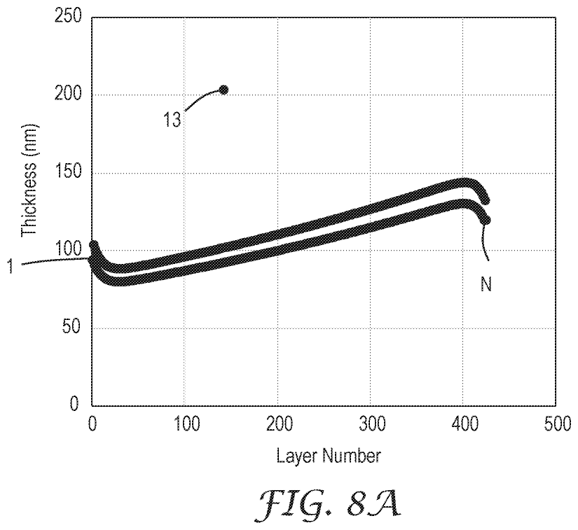

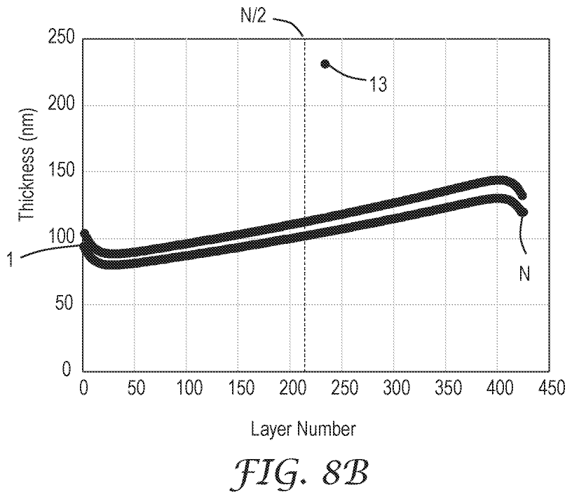

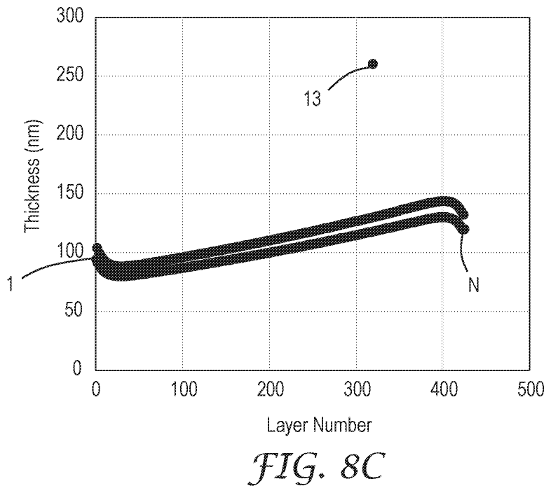

The wavelength at which the transmittance has a peak can be adjusted by selecting the location of the layer 13 in the optical film. FIGS. 8A-8C are plots of layer thickness versus layer number for various optical films, according to some embodiments. In some embodiments, the polymeric layers in the plurality of polymeric layers are sequentially arranged and numbered from 1 to N along a thickness direction (z-direction) of the multilayer optical film 200. In some embodiments, the sequence number of the (e.g., second polymeric) layer 13 is closer to 1 than to N as illustrated in FIG. 8A. In some embodiments, the sequence number of the (e.g., second polymeric) layer 13 is closer to N/2 than to either 1 or N as illustrated in FIG. 8B. In some embodiments, the sequence number of the (e.g., second polymeric) layer 13 is closer to N than to 1 as illustrated in FIG. 8C.

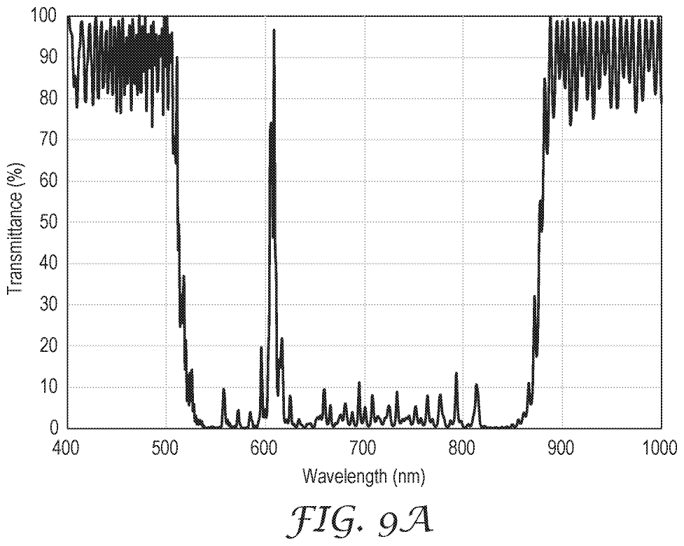

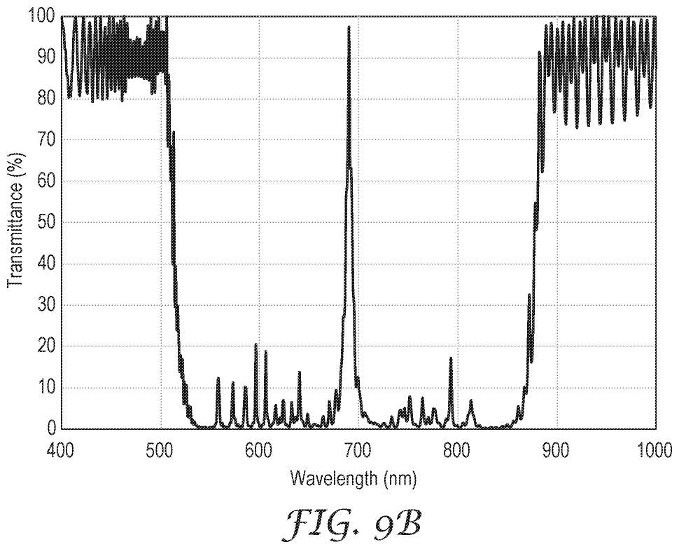

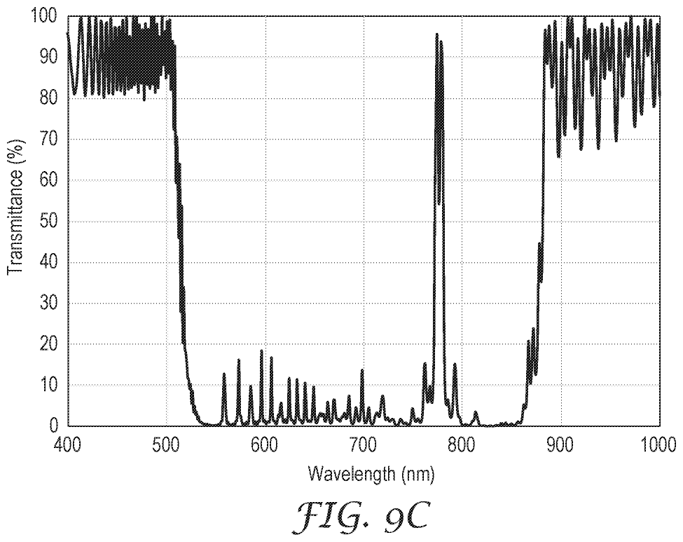

FIGS. 9A-9C are plots of optical transmittance versus wavelength for substantially normally incident light 20 for films having the layer thickness profiles of FIGS. 8A-8C, respectively, according to some embodiments. The plots can be for the incident light 20 can be polarized along the in-plane first direction. In some embodiments, the optical transmittance versus wavelength is substantially similar for the incident light 20 being polarized along the orthogonal in-plane second direction (e.g., the optical film can be an optical mirror). In other embodiments, the optical transmittance is greater than about 60%, or 70%, or 80%, or 90% throughout the illustrated wavelength range for the incident light 20 being polarized along the second direction (e.g., the optical film can be a reflective polarizer). The optical transmittances of FIGS. 9A-9C were calculated using standard optical modeling techniques for alternating layers of PET and coPMMA having the layer thickness profile shown in FIGS. 8A-8C where the cavity layer 13 was a coPMMA layer.

The thickness of the layer 13 can be adjusted to provide a largest peak transmittance. For example, in some embodiments, changing a thickness S of the (e.g., cavity) layer 13 reduces the peak transmittance (e.g., corresponding to T illustrated in FIG. 3B). FIG. 10 is a plot of optical transmittance versus wavelength for substantially normally incident light 20 for films having layers 13 with different thicknesses, according to some embodiments. Changing the thickness from 203.4 nm to 178 nm or to 228.8 nm reduces the peak transmittance. An optical film having the transmittance of FIG. 10 can be an optical mirror or a reflective polarizer for light polarized along a block axis, for example, as described further elsewhere herein. The optical transmittance of FIG. 10 was calculated using standard optical modeling techniques for alternating higher and lower index layers having isotropic indices of 1.65 and 1.5, respectively, and having a layer thickness profile similar to that of FIG. 8B. The refractive indices correspond approximately to the refractive indices at about 633 nm of OKP-1, PENG, or PHEN for the higher index layers and of PMMA or coPMMA for the lower index layers.

In some embodiments, a multilayer optical film 200, 210 includes a plurality of the layers 13, where each of the layers 13 causes the multilayer optical film to have a different local peak optical transmittance of greater than about 40%, or greater than about 50%, or greater than about 60%, or greater than about 70%, or greater than about 80%, or greater than about 90%. For example, the different local peak optical transmittance can be at different wavelengths such that adjacent wavelengths corresponding to adjacent local peak transmittances are spaced apart by at least about 10 nm, or at least about 20 nm, or at least about 30 mu, or at least about 40 nm. The adjacent wavelengths can be spaced apart by up to about 500 nm, or up to about 300 nm, or up to about 200 nm, for example. Each of the layers 13 causing the optical film to have a peak transmittance of greater than 40%, for example, means that if the layer 13 were omitted, the film would not have the peak transmittance of greater than 40%. For example, the peak transmittance can be located within a reflection band of the optical film so that if the layer 13 were omitted, the transmittance at the wavelength corresponding to the local peak can be less than 30%, or less than 20%, or less than 10%, or less than 5% for example.

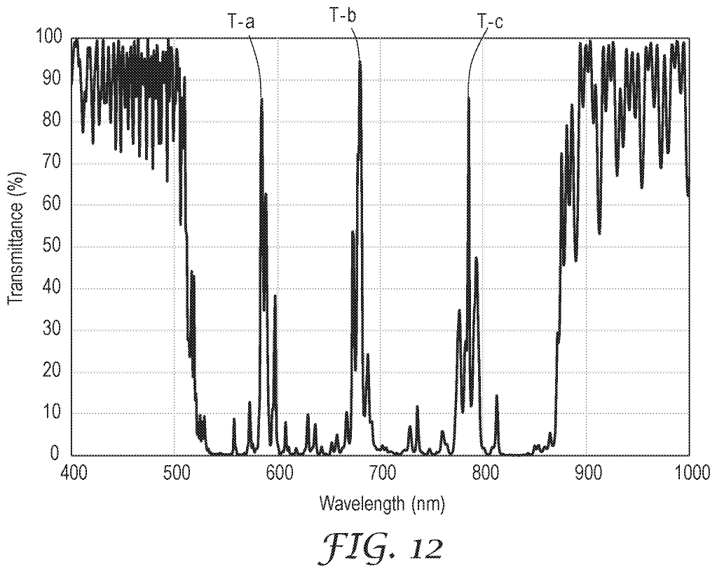

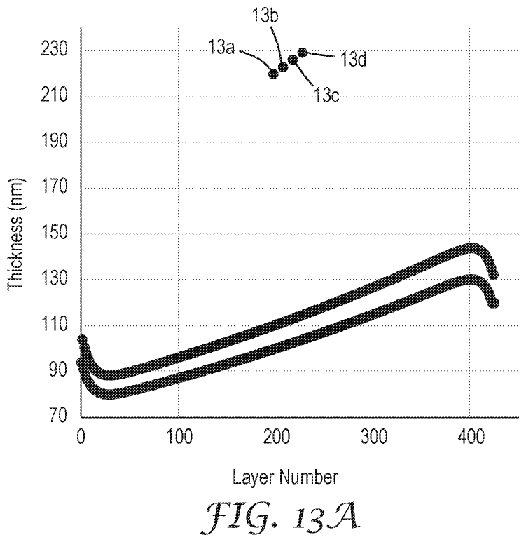

FIGS. 11A-11D are plots of layer thickness versus layer number for an optical film including three spaced apart spacer or cavity layers 13a, 13b, and 13c, according to some embodiments. FIG. 12 is a plot of the optical transmittance versus wavelength for an optical film having the layer thickness profile of FIGS. 11A-11D for substantially normally incident light, according to some embodiments. The substantially normally incidence light can be polarized along an in-plane first direction (e.g., in the case of a mirror film or in the case of a reflective polarizer where the first direction is a block direction of the reflective polarizer) or can be unpolarized (e.g., in the case of a mirror film). The optical transmittance of FIG. 12 was calculated using standard optical modeling techniques for alternating layers of PET and coPMMA having the layer thickness profile shown in FIGS. 11A-11D where the cavity layer 13 was a PET layer.

In some embodiments, a multilayer optical film 200, 210 includes a plurality of first layers 10, 11 and a plurality of second layers 13a, 13b, 13c, where each of the first and second layers has an average thickness of less than about 500 nm or in a range described elsewhere herein. In some embodiments, for each of the second layers: the second layer is disposed between, and adjacent to, two (10a, 10b, or 10c) of the first layers and has an average thickness that is greater than an average thickness of each of the two first layers; and the second layer causes the multilayer optical film to have a different local peak optical transmittance (T-a, T-b, T-c) of greater than about 40% or in a range described elsewhere herein. In some embodiments, for each of the second layers, the local peak optical transmittance is at a wavelength within about 30 nm, or within about 20 nm, or within about 10 nm, or within about 5 nm of 2 times an optical thickness of the second layer. In some embodiments, for each of the second layers, the local peak optical transmittance is at a wavelength substantially equal to twice an optical thickness of the second layer. In some embodiments, the different local peak optical transmittances are at a different wavelengths and the multilayer optical film 200, 210 has an optical reflectance of greater than about 50%, or greater than about 60%, or greater than about 70%, or greater than about 80%, or greater than about 90% for at least one wavelength within about 100 nm of at least one of the different wavelengths. The at least one wavelength can be within about 90 nm, or within about 80 nm, or within about 70 nm, or within about 60 nm, or within about 50 nm, or within about 40 nm, or within about 30 nm, or within about 20 nm, or within about 10 nm of at least one of the different wavelengths.

In some embodiments, a multilayer optical film 200, 210 includes a plurality of the layers 13, where the layers 13 are sufficiently near one another that the layers 13 collectively cause the multilayer optical film to have a peak optical transmittance of greater than about 60%, for example, or the peak optical transmittance can be in another range described elsewhere herein. The plurality of the layers 13 may result in a wider transmission band within a reflection band, for example, compared to including a single one of the layers 13.

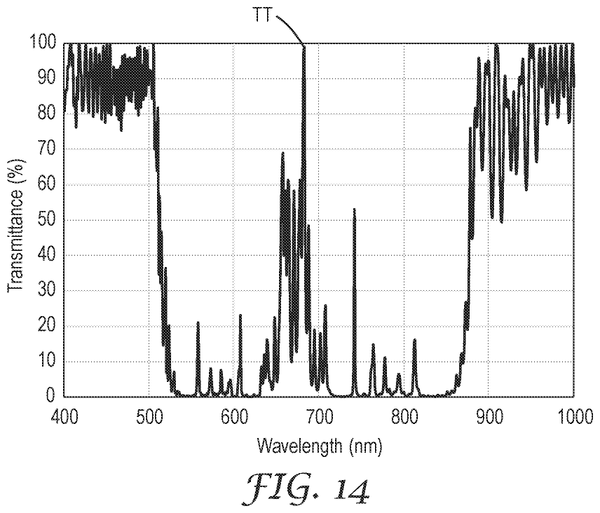

FIGS. 13A-13B is a plot of layer thickness versus layer number for an optical film with 4 close spacer or cavity layers 13a through 13d, according to some embodiments. FIG. 14 is a plot of the optical transmittance versus wavelength for an optical film having the layer thickness profile of FIGS. 13A-13B for substantially normally incident light, according to some embodiments. The substantially normally incidence light may be polarized along an in-plane first direction or may be unpolarized. The optical transmittance of FIG. 14 was calculated using standard optical modeling techniques for alternating layers of PET and coPMMA having the layer thickness profile shown in FIGS. 13A-13B where the cavity layer 13 was a coPMMA layer.

In some embodiments, a multilayer optical film 200, 210 includes a plurality of first layers 10, 11 and a plurality of second layers (13a through 13d) sequentially arranged and numbered along a thickness direction (z-direction) of the optical film so that each of the second layers is disposed between, and adjacent to, two (10a through 10d) of the first layers. Each of the first and second layers have an average thickness of less than about 500 nm or in another range described elsewhere herein. In some embodiments, the second layers are sufficiently near one another in the sequence of the layers that, in combination, they cause the multilayer optical film to have a peak optical transmittance TT of greater than about 40%, or greater than about 50%, or greater than about 60%, or greater than about 70%, or greater than about 80%, or greater than about 90%, for example. In some embodiments, the plurality of second layers includes a layer (e.g., 10d) having a largest optical thickness and a layer (e.g., 10a) having a smallest optical thickness. The peak optical transmittance can be at a wavelength between S1 times the smallest optical thickness and S2 times the largest optical thickness, where S1 can be 1.9 and S2 can be 2.1. In some embodiments, S1 is 1.9, or 1.95, or 1.98, or 1.99, or 2. In some such embodiments, or in other embodiments, S2 is 2.1, or 2.05, or 2.02, or 2.01, or 2. In some such embodiments, or in other embodiments, the peak optical transmittance is at a first wavelength and the multilayer optical film 200, 210 has an optical reflectance of greater than about 50%, or greater than about 60%, or greater than about 70%, or greater than about 80%, or greater than about 90% for at least one second wavelength within about 100 nm of the first wavelength. The second wavelength can be within about 90 nm, or within about 80 nm, or within about 70 nm, or within about 60 nm, or within about 50 nm, or within about 40 nm, or within about 30 nm, or within about 20 nm of the first wavelength, for example.

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

Terms such as “substantially equal” will be understood in the context in which they are used and described in the present description by one of ordinary skill in the art. If the use of “substantially equal” as applied to first and second quantities expressing feature sizes, amounts, and physical properties is not otherwise clear to one of ordinary skill in the art in the context in which it is used and described in the present description, “substantially equal” will be understood to mean that the first quantity is within 5 percent of the second quantity. Quantities said to be substantially equal may be precisely equal. For example, if it is not otherwise clear to one of ordinary skill in the art in the context in which it is used and described in the present description, a first quantity being substantially equal to a second quantity, means that the first quantity has a value between 0.95 and 1.05 times the value of the second quantity, and that the values could be equal.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations, or variations, or combinations of the specific embodiments discussed herein. Therefore, it is intended that this disclosure be limited only by the claims and the equivalents thereof.

1-10. (canceled)

11. A multilayer optical film comprising a plurality of polymeric layers transmitting at least 30% of a substantially normally incident light having a first wavelength and polarized along an in-plane first direction of the polymeric layers, each of the polymeric layers having an average thickness of less than about 500 nm, first, second and third polymeric layers in the plurality of polymeric layers disposed sequentially adjacent to each other and having respective indices of refraction n1, n2 and n3 along the first direction at the first wavelength and respective average thicknesses d1, d2 and d3, wherein n2d2 is within about 40% of m(n1d1+n3d3), where m is a positive integer.

12. The multilayer optical film of claim 11 reflecting at least 50% of the substantially normally incident light having a second wavelength and polarized along the in-plane first direction, the second wavelength within about 100 nm of the first wavelength.

13. The multilayer optical film of claim 11, wherein the plurality of polymeric layers comprises first and second pluralities of optical repeat units (ORUs), each of the ORUs comprising at least two of the polymeric layers, first and second ORUs in the respective first and second pluralities of ORUs comprising the first and third polymeric layers, respectively, the second polymeric layer being the only layer of the multilayer optical film disposed between the first and second pluralities of ORUs.

14. The multilayer optical film of claim 13, wherein for the first wavelength and the in-plane first direction, the ORUs have an f-ratio of 0.5, the at least two of the polymeric layers of each of the ORUs comprising higher and lower refractive index layers, the f-ratio being a ratio of an optical thickness of the higher index layer to a total optical thickness of the ORU.

15. The multilayer optical film of claim 13, wherein the first and second ORUs have optical thicknesses substantially equal to a half of respective wavelengths L1 and L2 that are within 100 nm of each other, the second polymeric layer having an optical thickness substantially equal to a half of a wavelength L3 disposed between L1 and L2.

16. The multilayer optical film of claim 13, wherein the first and second pluralities of ORUs comprise respective first and second optical mirrors, such that for the substantially normally incident light, a second wavelength spaced apart from the first wavelength by about 2 nm to about 100 nm, and a third wavelength disposed between the first and second wavelengths:
the first and second optical mirrors have respective optical transmittances T1 and T2 at the first wavelength, respective optical transmittances T1′ and T2′ at the second wavelength, and respective optical transmittances T1″ and T2″ at the third wavelength, T2>2T1, T1′>2T2′; and
the multilayer optical film has an optical transmittance T at the third wavelength, T>T1″ and T2″.

17. The multilayer optical film of claim 13, wherein the first and second pluralities of ORUs comprise respective first and second optical mirrors, the second polymeric layer defining a resonant cavity resonant at at least one resonant wavelength, each of the first and second optical mirrors having an optical reflectance of at least 25% for substantially normally incident light at the at least one resonant wavelength, wherein for an incident light substantially normally incident on the multilayer optical film at the least one resonant wavelength, the first and second optical mirrors reflects portions of the incident light in a substantially same direction as respective first and second reflected lights, the first and second reflected lights destructively interfering with each other outside the resonant cavity.

18. A multilayer optical film comprising a first plurality of first polymeric layers alternating with a second plurality of second polymeric layers, a difference between average refractive indices of the first polymeric layers and average refractive indices of the second polymeric layers along an in-plane first direction of the multilayer optical film in a predetermined wavelength range of between about 50 nm and about 150 nm wide being sufficiently large and thicknesses of the first and second polymeric layers changing across at least a portion of a thickness of the multilayer optical film so that the multilayer optical film has an average optical reflectance of at least 50% for a substantially normally incident light polarized along the in-plane first direction in the predetermined wavelength range, wherein for a group of three adjacent and sequentially arranged polymeric layers in the pluralities of first and second polymeric layers, the three polymeric layers have respective average thicknesses d1, d2 and d3, wherein d2 is within about 40% of m(d1+d3), where m is a positive integer.

19. The multilayer optical film of claim 18, wherein d2 is less than about 400 nm.

20. The multilayer optical film of claim 18 comprising first and second pluralities of optical repeat units (ORUs), each of the ORUs comprising one of the first polymeric layers and an adjacent one of the second polymeric layers, each of first and second ORUs in the respective first and second pluralities of ORUs comprising one layer of the group of three adjacent and sequentially arranged polymeric layers, a remaining layer of the group being the only layer of the multilayer optical film disposed between the first and second pluralities of ORUs.

21. The multilayer optical film of claim 20, wherein the ORUs have an f-ratio of 0.5, the f-ratio being a ratio of an optical thickness of the first polymeric layer of an ORU to a total optical thickness of the ORU.

22. The multilayer optical film of claim 20, wherein the first and second ORUs have optical thicknesses substantially equal to a half of respective wavelengths L1 and L2 that are within 100 nm of each other, the remaining layer of the group having an optical thickness substantially equal to a half of a wavelength L3 disposed between L1 and L2.

23. The multilayer optical film of claim 20, wherein the first and second pluralities of ORUs comprise respective first and second optical mirrors, such that for the substantially normally incident light, first and second wavelengths spaced apart by about 2 nm to about 100 nm, and a third wavelength disposed between the first and second wavelengths:
the first and second optical mirrors have respective optical transmittances T1 and T2 at the first wavelength, respective optical transmittances T1′ and T2′ at the second wavelength, and respective optical transmittances T1″ and T2″ at the third wavelength, T2>2T1, T1′>2T2′; and
the multilayer optical film has an optical transmittance T at the third wavelength, T>T1″ and T2″.

24. The multilayer optical film of claim 20, wherein the first and second pluralities of ORUs comprise respective first and second optical mirrors, the remaining layer of the group defining a resonant cavity resonant at at least one resonant wavelength, each of the first and second optical mirrors having an optical reflectance of at least 25% for substantially normally incident light at the at least one resonant wavelength, wherein for an incident light substantially normally incident on the multilayer optical film at the least one resonant wavelength, the first and second optical mirrors reflects portions of the incident light in a substantially same direction as respective first and second reflected lights, the first and second reflected lights destructively interfering with each other outside the resonant cavity.

25. A multilayer optical film comprising a plurality of optical repeat units (ORUs) numbering at least 10 in total, each of the ORUs having at least two polymeric layers, each of the ORUs having an optical thickness substantially equal to a half of a wavelength in a predetermined wavelength range extending from about 300 nm to about 2500 nm, at least first and second ORUs in the plurality of ORUs having optical thicknesses substantially equal to a half of respective wavelengths L1 and L2 that are within 100 nm of each other, the first and second ORUs having a single polymeric first layer disposed therebetween, the first layer having an optical thickness substantially equal to a half of a wavelength L3 disposed between L1 and L2.

26. The multilayer optical film of claim 25, wherein L1 and L2 are within 20 nm of each other.

27. The multilayer optical film of claim 25 transmitting at least 30% of a substantially normally incident light having a first wavelength between L1 and L2 and polarized along an in-plane first direction of the multilayer optical film.

28. The multilayer optical film of claim 27, wherein the first wavelength is substantially equal to L3.

29. The multilayer optical film of claim 27 reflecting at least 30% of a substantially normally incident light having a second wavelength within about 50 nm of L3 and polarized along the in-plane first direction of the multilayer optical film.
